(19) United States
(12) Patent Application Publication
(10) Pub. No.: US 2003/0229087 A1
(43) Pub. Date: Dec. 11, 2003

(54) Fungicidal combinations of active agents

(76) Inventors: Astrid Mauler-Machnik, Leichlingen (DE); Ulrike Wachendorff-Neumann, Neuwied (DE); Herbert Gayer, Monheim (DE)

Correspondence Address: BAYER POLYMERS LLC, 100 BAYER ROAD, PITTSBURGH, PA, 15205, US

(21) Appl. No.: 10/275,500

(22) PCT Filed: Apr. 30, 2001
(86) PCT No.: PCT/EP01/04844

(51) Int. Cl. A01N 43/58; A01N 43/60; A01N 43/54; A01N 43/40; A01N 37/18; A01N 47/10; A01N 43/38

(52) U.S. Cl. 514/229.2; 514/269; 514/357; 514/235.8; 514/266.23; 514/346; 514/250; 514/416; 514/487; 514/613

(57) ABSTRACT

Novel active compound combinations of compounds of the formula (I)

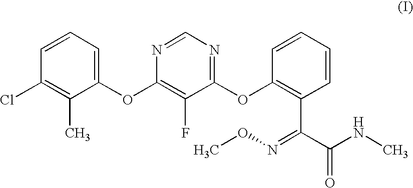

and known active compounds and their use for controlling phytopathogenic fungi are described.

The present invention relates to novel active compound combinations comprising a known halogenopyrimidine derivative and further known active compounds, which compositions are highly suitable for controlling phytopathogenic fungi.

It is already known that (2E/Z)-2-(2-{[6-(3-chloro-2-methylphenoxy)-5-fluoro-4-pyrimidinyl]oxy}phenyl)-2-(methoxyimino)-N-methylethanamide has fungicidal properties (cf. EP-A1-937 050). The activity of this substance is good; however, at low application rates, it is sometimes unsatisfactory.

Furthermore, it is already known that numerous azole derivatives, aromatic carboxylic acid derivatives, morpholine compounds and other heterocycles can be used for controlling fungi (cf. K. H. Buchel “Pflanzenschutz und Schädlings-bekämpfung” [Crop protection and pest control] pages 87, 136, 140, 141 and 146 to 153, Georg Thieme Verlag, Stuttgart 1977). However, the activity of the substances in question is not always satisfactory at low application rates.

It has now been found that the novel active compound combinations of compounds of the formula (I)

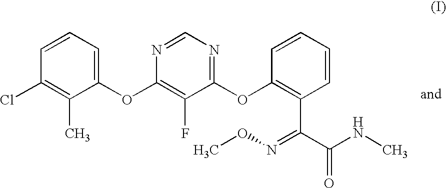

(1) 8-t-butyl-2-(N-ethyl-N-n-propyl-amino)-methyl-1,4-dioxaspiro-[5,4]-decane (reference: EP-A-0 281 842) of the formula

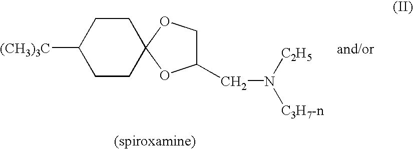

(2) 5,7-dichloro-4-(4-fluorophenoxy)-quinoline (reference: EP-A-326 330) of the formula

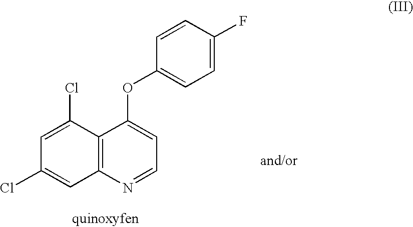

(3) the triazole derivative (reference: EP-A-0 040 345) of the formula

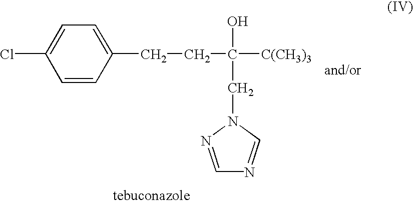

(4) 1-[3-[4-(1,1-dimethylethyl)phenyl]-2-methylpropyl]piperidine (reference: DE-A-2 752 153) of the formula

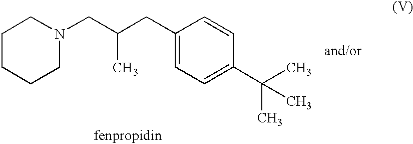

(5) (+−)-cis-4-[3-[4-(1,1-dimethylethyl)phenyl]-2-methylpropyl]-2,6-dimethylmorpholine (reference: DE-A-2 656 747) of the formula

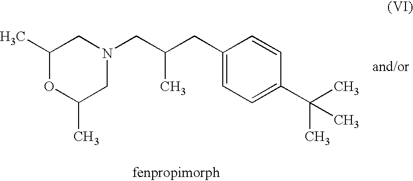

(6) N-(1-cyano-1,2-dimethylpropyl)-2-(2,4-dichlorophenoxy)-propanamide (reference: EP-A 262 393) of the formula

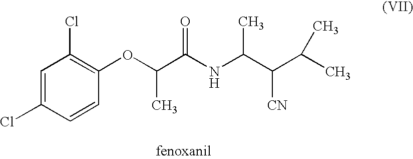

and/or

(7) tetrachloro-isophthalo-dinitrile (reference: U.S. Pat. No. 3,290,353) of the formula

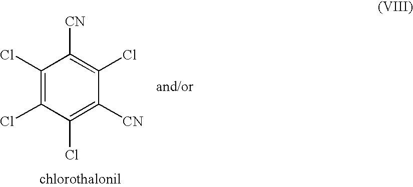

(8) 1-(4-chloro-phenoxy)-3,3-dimethyl-1-(1,2,4-tri azol-1-yl)-butan-2-one (reference: DE-A-2 201 063) of the formula

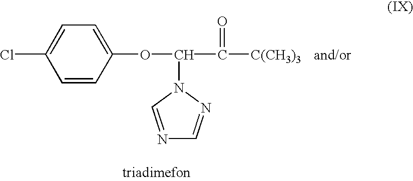

(9) 1-(4-chloro-phenoxy)-3,3-dimethyl-1-(1,2,4-triazol-1-yl)-butan-2-ol (reference: DE-A-23 24 010) of the formula

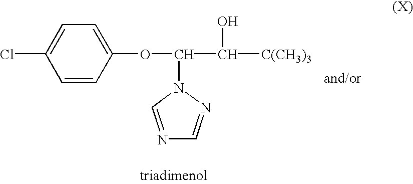

(10) the triazole (reference: EP-A-196 038) of the formula epoxiconazole

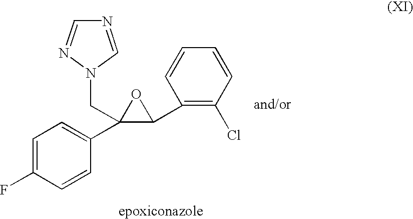

(11) the triazole (reference: EP-A-329 397) of the formula

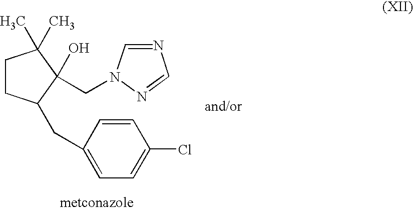

(12) the triazole (reference: EP-A-183 458) of the formula

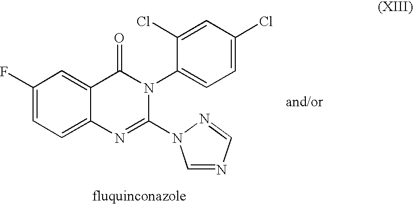

(13) the triazole (reference: DE-A-3 406 993) of the formula

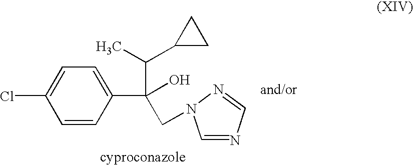

(14) the triazole (reference: Pesticide Manual, 9th. Ed. (1991), page 654) of the formula

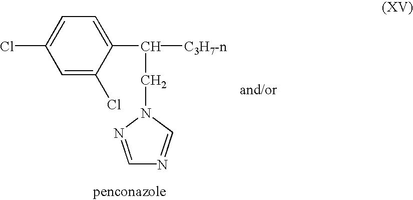

(15) the compound (reference: EP-A-253 213) of the formula

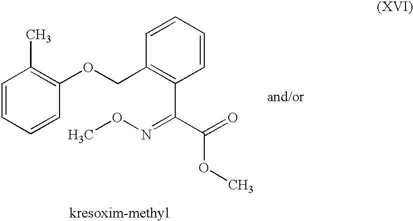

(16) the compound (reference: EP-A-0 382 375) of the formula

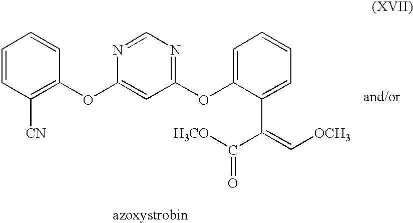

(17) the compound (reference: EP-A-0 310 550) of the formula

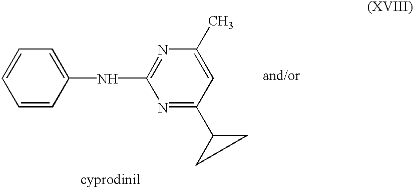

(18) N,N′″-(iminodi-8,1-octanediyl)bis-guanidine triacetate (reference: EP-A-155 509) of the formula

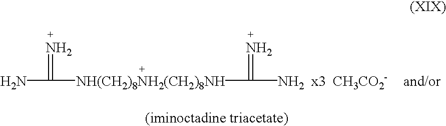

(19) the triazole (reference: EP-A-068 813) of the formula

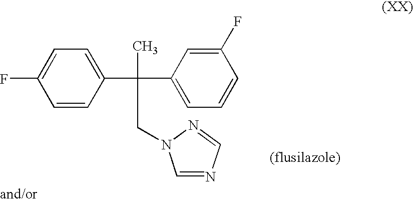

(20) the imidazole derivative (reference: DE-A-2 429 523) of the formula

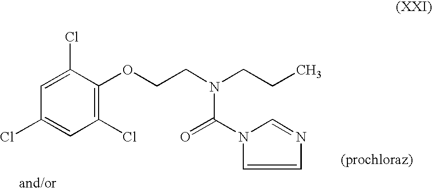

(21) the triazole (reference: DE-A-2 551 560) of the formula

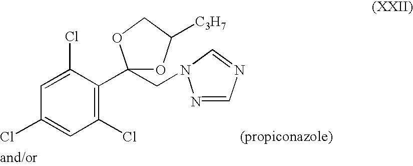

(22) 1-(4-phenyl-phenoxy)-3,3-dimethyl-1-(1,2,4-triazol-1-yl)-butan-2-ol (reference: DE-A-2 324 010) of the formula

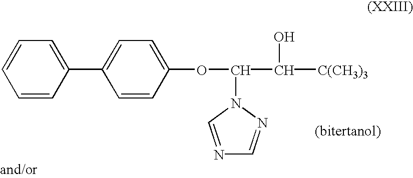

(23) 1-[(6-chloro-3-pyridinyl)-methyl]-N-nitro-2-imidazolidinimine (reference:

Pesticide Manual, 9th. Ed. (1991), page 491) of the formula

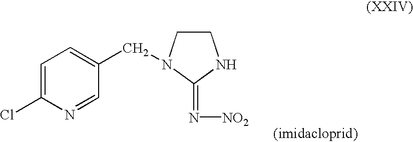

and/or

(24) the aniline derivative (reference: DE-A-1 193 498) of the formula

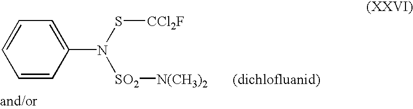

(25) the aniline derivative (reference: DE-A-1 19 34 98) of the formula

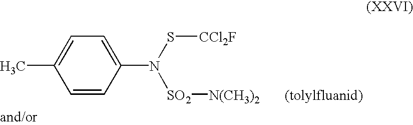

(26) the aniline derivative (reference: Pesticide Manual, 9th. Ed. (1991), page 554) of the formula

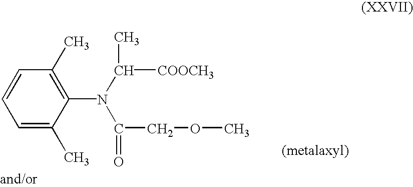

(27) 4-(2,3-dichlorophenyl)-1H-pyrrole-3-carbonitrile (reference: EP-A-236 272) of the formula

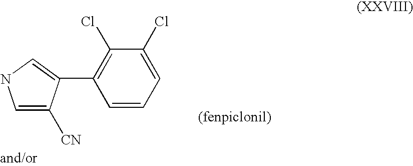

(28) the triazole derivative (reference: EP-A-1 12 284) of the formula

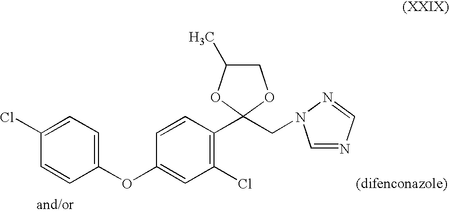

(29) the pyrrole derivative (reference: EP-A-206 999) of the formula

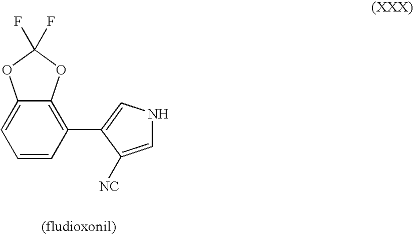

and/or

(30) the benzimidazole derivative (reference: U.S. Pat. No. 3,010,968) of the formula

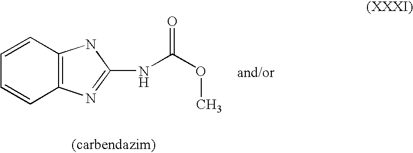

(31) the compound (reference: CASRN (3878-19-1)) of the formula

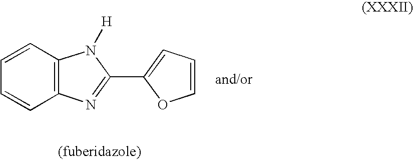

(32) the imidazole derivative (reference: DE-A-2 063 857) of the formula

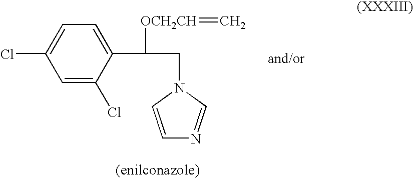

(33) the imadizole derivative of the formula

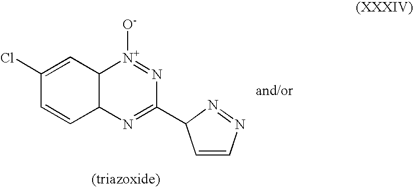

(34) the compound (reference: DE-A-2 709 264) of the formula

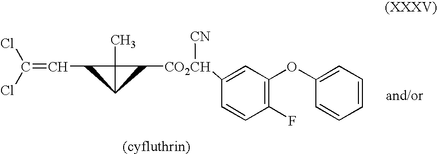

(35) a guanidine derivative (reference: Pesticide Manual, 9th. Ed. (1991), page 461) of the formula

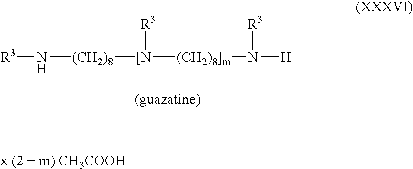

in which

m represents integers from 0 to 5 and

R³ represents hydrogen (17 to 23%) or the radical of the formula

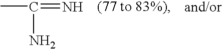

(36) the benzothiadiazole derivative (reference: EP-A-0 313 512) of the formula

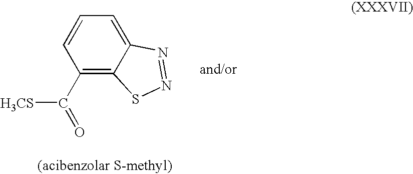

(37) the urea derivative (reference: DE-A-2 732 257) of the formula

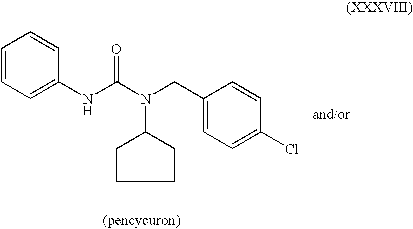

(38) the benzamide derivative (reference: DE-A-2 731 522) of the formula

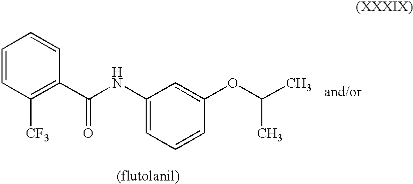

(39) the benzothiazole derivative (reference: DE-A-2 250 077) of the formula

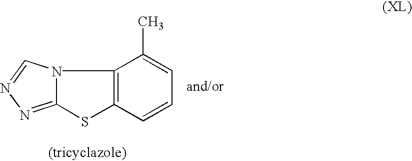

(40) the zinc propylene-1,2-bis-(dithiocarbamidate) (reference: Pesticide Manual, 9th. Ed. (1991), page 726) of the formula

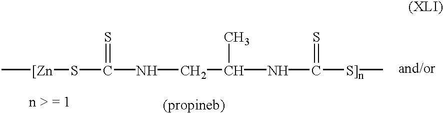

(41) the compound (reference: DE-A-2 012 656) of the formula

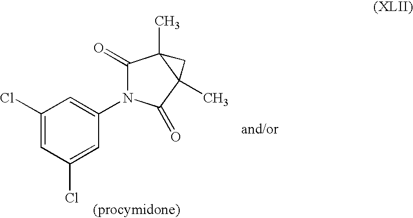

(42) a thiocarbamate (reference: Pesticide Manual, 9th. Ed. (1991)) of the formula

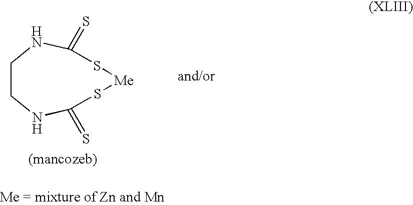

(43) the phthalimide derivative (reference: Pesticide Manual, 9th. Ed. (1991), page 431) of the formula

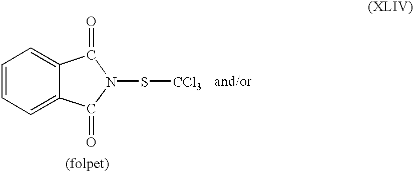

(44) the morpholine derivative (reference: EP-A-0 219 756) of the formula

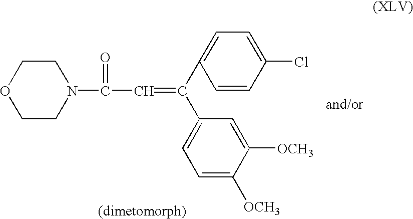

(45) the cyanoxime derivative (reference: Pesticide Manual, 9th. Ed. (1991), page 206) of the formula

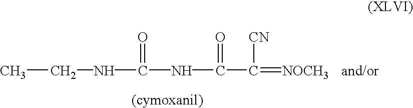

(46) the phosphorus compound (reference: Pesticide Manual, 9th. Ed. (1991), page 443) of the formula

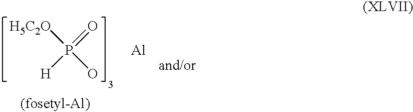

(47) the oxazolidindione (reference: EP-A-0 393 911) of the formula

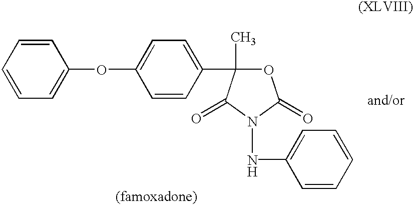

(48) the pyrimidine derivative (reference: EP-A-0 270 111) of the formula

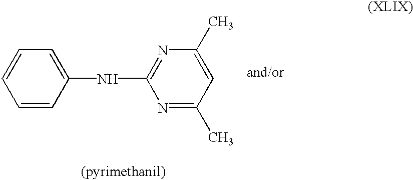

(49) the pyrimidine derivative (reference: EP-A-0 270 111) of the formula

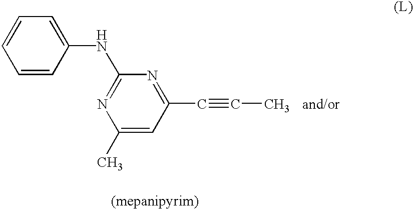

(50) the compound (reference: EP-A-0 472 996) of the formula

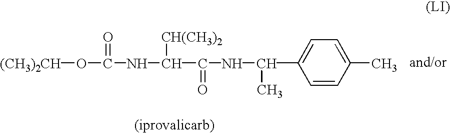

and/or

(51) the aniline derivative (reference: EP-A-0 339 418) of the formula

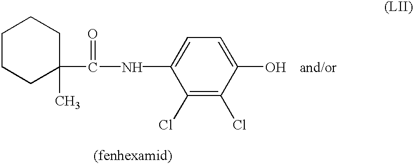

(52) N-[1-(4-chloro-phenyl)-ethyl]-2,2-dichloro-1-ethyl-3-methyl-cyclopropane-carboxamide (reference: EP-A-0 341 475) of the formula

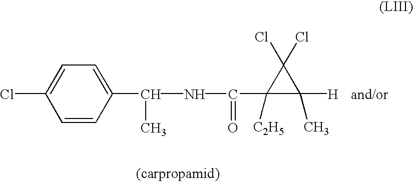

(53) the pyridinamine (reference: EP-A-0 031 257) of the formula

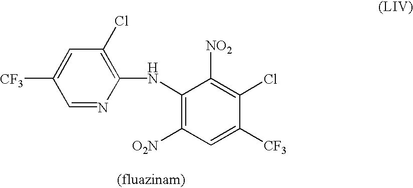

and/or

(54) the dicarboxiome derivative (reference: U.S. Pat. No. 2,553,770) of the formula

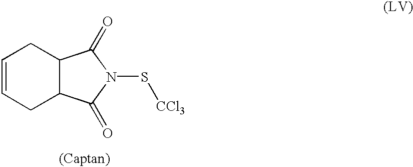

(55) the compound (reference: DE-A-1 100 372) of the formula

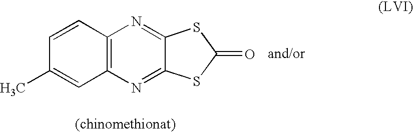

(56) the compound (reference: EP-A-0 629 616) of the formula

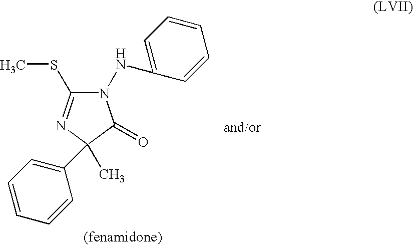

(57) the compound (reference: EP-A-376 279) of the formula

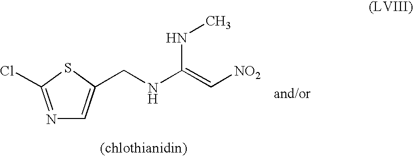

(58) the compound (reference: EP-A-235 725) of the formula

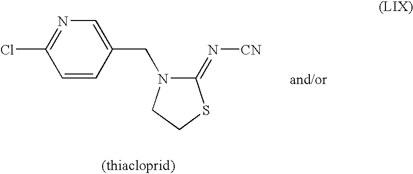

(59) the compound (reference: EP-A-580 553) of the formula

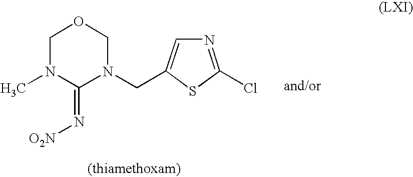

(60) the compound (reference: WO-A-91-4965) of the formula

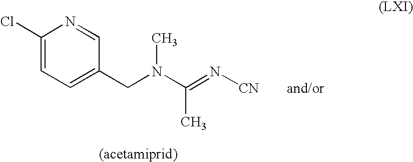

(61) the compound (reference: EP-A-326 330) of the formula

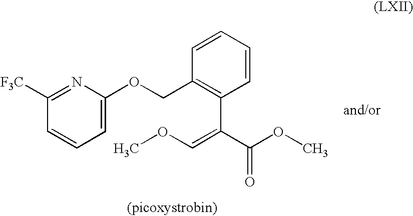

(62) sulphur (LXIII)

and/or

(63) copper oxychloride (LXIV)

and/or

(64) the compound (reference: DE-A-2 149 923) of the formula

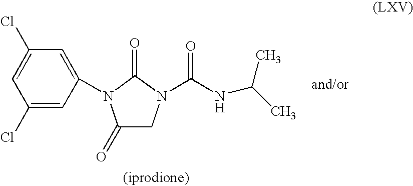

(65) the compound (reference: DE-A-2 207 576) of the formula

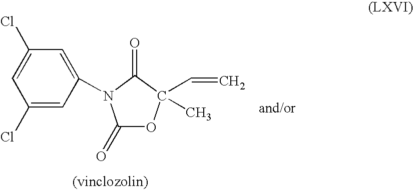

(66) the compound (reference: JP-A-575 584) of the formula

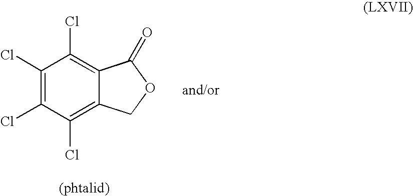

(67) the compound (reference: DE-A-2 300 299) of the formula

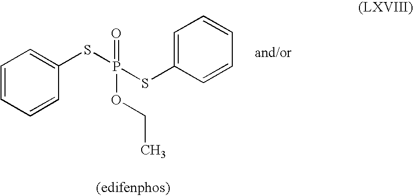

(68) the compound (reference: U.S. Pat. No. 3,917,838) of the formula

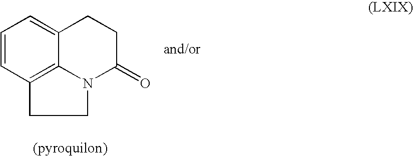

(69) the hydroxyethyl-triazole derivative (reference: WO-A-96-16048) of the formula

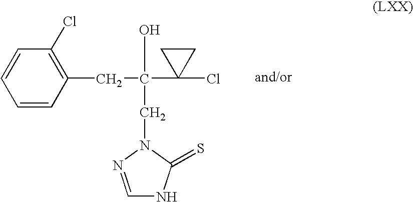

(70) the halogeno-benzimidazole (reference: WO-A-97-0617 1) of the formula

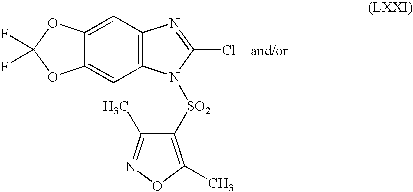

(71) the compound (reference: DE-A-19 602 095) of the formula

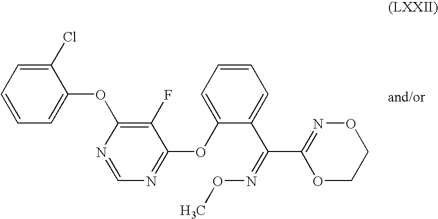

(72) the benzamide derivative (reference: EP-A-0 600 629) of the formula

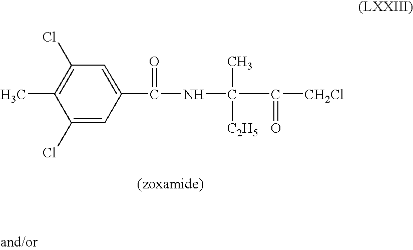

(73) the compound (reference: EP-A-298 196) of the formula

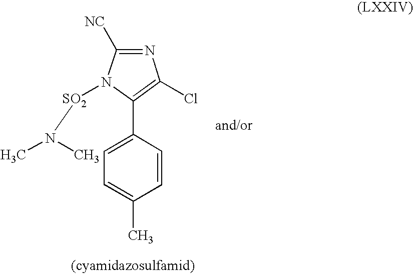

(74) the compound (reference: WO-A-96-18631) of the formula

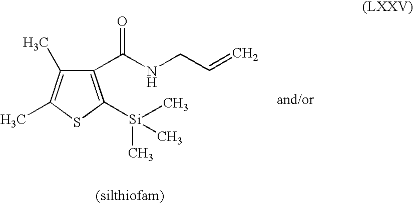

(75) the compound (reference: EP-A-460 575) of the formula

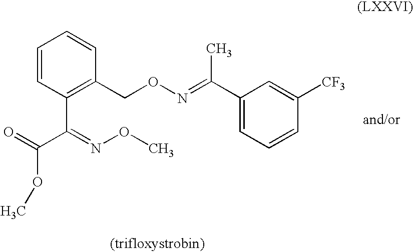

(76) N-methyl-2-(methoxyimino)-2-[2-([1-(3-tri-fluoro-methyl-phenyl)ethoxy]-iminomethyl)phenyl]acetamide (reference: EP-A-596 254) of the formula

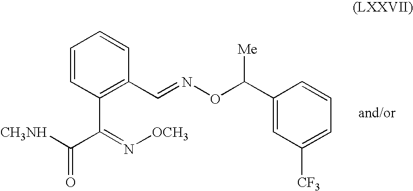

(77) 2-[2-([2-phenyl-2-methoxyimino-1-methylethyl]-imino-oxymethyl)phenyl]-2-methoxyimino-N-methylacetamide (reference: WO-A-95-21154) of the formula

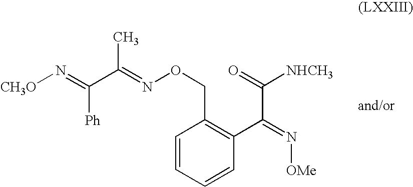

(78) 2-[2-([2-(4-fluorophenyl)-2-methoxyimino-1-methylethyl]iminooxymethyl)phenyl]-2-methoxyimino-N-methyl-acetamide (reference: WO-A-95-21154) of the formula

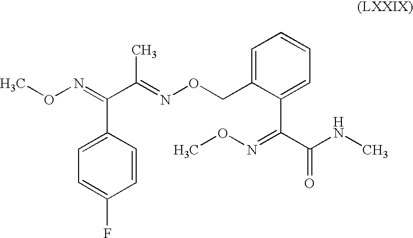

and/or

(79) 2-[4-methoxy-3-(1-methylethoxy)-1,4-diazabuta-1,3-dienyl-oxy-methyl]phenyl-2-methoximino-N-methyl-acetamide (reference: DE-A-19 528 651) of the formula

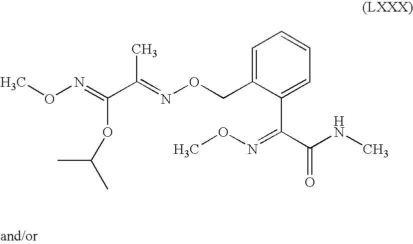

(80) methyl N-(2-[1-(4-chlorophenyl)pyrazol-3-yloxymethyl]phenyl)-N-methoxycarbamate (reference: DE-A-4 423 612) of the formula

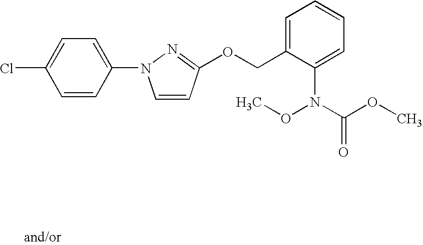

(81) 2,4-dihydro-5-methoxy-2-methyl-4-[2-([([1-(3-tri-fluoro-methyl-phenyl)ethylidene]amino)oxy]methyl)phenyl]-3H-1,2,4-tri azol-3-one (reference: WO-A-98-23 155) of the formula

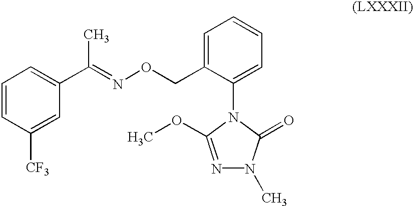

and/or

(82) the compound of the formula (reference: U.S. Pat. No. 3,631,176)

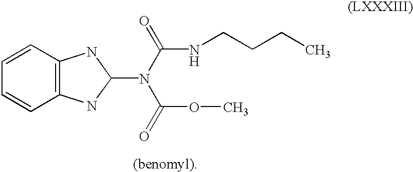

have very good fungicidal properties.

Surprisingly, the fungicidal action of the active compound combinations according to the invention is considerably higher than the sum of the actions of the individual active compounds. Thus, an unforeseeable true synergistic effect is present, and not just an addition of activities.

It is evident from the structural formula of the active compound of formula (I) that the compound can be present as E or Z isomer. Accordingly, the product can be present as a mixture of different isomers or else in the form of a single isomer. Preference is given to compounds of the formula (I) in which the compound o f the formula (I) is present as E isomer.

The active compound of the formula (I) is known (compare, for example, DE-A 19 646 407).

The other active compounds present in the combinations according to the invention are likewise known (cf. references).

In addition to an active compound of the formula (I), the active compound combinations according to the invention comprise at least one active compound from among the compounds of groups (1) to (82). In addition, they may also comprise further fungicidally active additives.

If the active compounds in the active compound combinations according to the invention are present in certain weight ratios, the synergistic effect is particularly pronounced. However, the weight ratios of the active compounds in the active compound combinations can be varied within a relatively wide range. In general, the combinations according to the invention comprise the active compound of the formula (I) and the mixing partner in the preferred and particularly preferred mixing ratios given in the table below:

the mixing ratios are based on weight ratios. The ratio is to be understood as active compound of the formula I: mixing partner

| | | particularly |
|---|---|---|
| | preferred | preferred |
| | mixing | mixing |
| Mixing partner | ratio* | ratio* |
| spiroxamine | 10:1 to 1:20 | 5:1 to 1:10 |
| quinoxyfen | 10:1 to 1:20 | 5:1 to 1:10 |
| tebuconazole | 10:1 to 1:10 | 5:1 to 1:5 |
| fenpropidin | 10:1 to 1:20 | 5:1 to 1:10 |
| fenpropimorph | 10:1 to 1:20 | 5:1 to 1:10 |
| N-(1-cyano-1,2-dimethylpropyl)-2-(2,4- | 10:1 to 1:10 | 5:1 to 1:5 |
| dichloro-phenoxy)propionamide, (R,S)- and | | |
| (R,R)- and (S,R)- and (S,S)- | | |
| chlorothalonil | 1:1 to 1:50 | 1:5 to 1:20 |
| triadimefon | 10:1 to 1:10 | 5:1 to 1:5 |
| triadimenol | 10:1 to 1:10 | 5:1 to 1:5 |
| epoxiconazole | 10:1 to 1:10 | 5:1 to 1:5 |
| metconazole | 10:1 to 1:10 | 5:1 to 1:5 |
| fluquinconazole | 10:1 to 1:10 | 5:1 to 1:5 |
| cyproconazole | 10:1 to 1:10 | 5:1 to 1:5 |
| penconazole | 10:1 to 1:10 | 5:1 to 1:5 |
| kresoximmethyl | 10:1 to 1:10 | 5:1 to 1:5 |
| azoxystrobin | 10:1 to 1:10 | 5:1 to 1:5 |
| cyprodinil | 5:1 to 1:20 | 1:1 to 1:10 |
| iminoctadine triacetate | 10:1 to 1:10 | 5:1 to 1:5 |
| flusilazole | 10:1 to 1:10 | 5:1 to 1:5 |
| prochloraz | 10:1 to 1:10 | 5:1 to 1:5 |
| propiconazole | 10:1 to 1:10 | 5:1 to 1:5 |
| bitertanol | 10:1 to 1:10 | 5:1 to 1:5 |
| imidacloprid | 20:1 to 1:20 | 10:1 to 1:10 |
| dichlofluanid | 1:1 to 1:50 | 1:1 to 1:20 |
| tolylfluanid | 1:1 to 1:50 | 1:1 to 1:20 |
| metalaxyl | 10:1 to 1:10 | 5:1 to 1:5 |
| fenpiclonil | 10:1 to 1:10 | 5:1 to 1:5 |
| difenoconazole | 10:1 to 1:10 | 5:1 to 1:5 |
| fludioxonil | 10:1 to 1:10 | 5:1 to 1:5 |
| carbendazim | 10:1 to 1:10 | 5:1 to 1:5 |
| fuberidazole | 20:1 to 1:10 | 10:1 to 1:5 |
| enilconazole | 20:1 to 1:10 | 10:1 to 1:5 |
| triazoxide | 20:1 to 1:10 | 10:1 to 1:5 |
| cyfluthrin | 20:1 to 1:20 | 10:1 to 1:10 |
| guazatine | 10:1 to 1:10 | 5:1 to 1:5 |
| acibenzolar-S-methyl | 50:1 to 1:50 | 20:1 to 1:10 |
| pencycuron | 10:1 to 1:10 | 5:1 to 1:5 |
| flutolanil | 10:1 to 1:10 | 5:1 to 1:5 |
| tricyclazole | 10:1 to 1:10 | 5:1 to 1:5 |
| propineb | 1:1 to 1:50 | 1:5 to 1:20 |
| procymidone | 10:1 to 1:10 | 5:1 to 1:5 |
| mancozeb | 1:1 to 1:50 | 1:5 to 1:20 |
| folpet | 1:1 to 1:50 | 1:5 to 1:20 |
| dimetomorph | 10:1 to 1:10 | 5:1 to 1:5 |
| cymoxanil | 10:1 to 1:10 | 5:1 to 1:5 |
| fosetyl-Al | 10:1 to 1:50 | 1:1 to 1:10 |
| famoxadone | 10:1 to 1:10 | 5:1 to 1:5 |
| pyrimethanil | 5:1 to 1:20 | 1:1 to 1:10 |
| mepanipyrim | 5:1 to 1:20 | 1:1 to 1:10 |
| iprovalicarb | 10:1 to 1:10 | 5:1 to 1:5 |
| fenhexamid | 10:1 to 1:10 | 5:1 to 1:5 |
| carpropamid | 10:1 to 1:10 | 5:1 to 1:5 |
| fluazinam | 10:1 to 1:10 | 5:1 to 1:5 |
| captan | 5:1 to 1:50 | 1:1 to 1:20 |
| chinomethionat | 5:1 to 1:50 | 1:1 to 1:20 |
| fenamidone | 10:1 to 1:10 | 5:1 to 1:5 |
| clothianidin | 20:1 to 1:20 | 10:1 to 1:10 |
| thiacloprid | 20:1 to 1:20 | 10:1 to 1:10 |
| thiamethoxan | 20:1 to 1:20 | 10:1 to 1:10 |
| acetamiprid | 20:1 to 1:20 | 10:1 to 1:10 |
| picoxystrobin | 10:1 to 1:10 | 5:1 to 1:5 |
| sulphur | 20:1 to 1:20 | 10:1 to 1:10 |
| copper | 20:1 to 1:20 | 10:1 to 1:10 |
| iprodione | 10:1 to 1:10 | 5:1 to 1:5 |
| vinclozolin | 10:1 to 1:10 | 5:1 to 1:5 |
| phtalid | 10:1 to 1:10 | 5:1 to 1:5 |
| edifenphos | 10:1 to 1:10 | 5:1 to 1:5 |
| pyroquilon | 10:1 to 1:10 | 5:1 to 1:5 |
| 2-(1-chloro-cyclopropyl)-1-(2-chlorophenyl)- | 20:1 to 1:5 | 20:1 to 1:5 |
| 3-(5-mercapto-1,2,4-triazol-1-yl)-propan-2-ol | | |
| 1-(3,5-dimethylisoxazole-4-sulphonyl)-2- | 50:1 to 1:10 | 20:1 to 1:5 |
| chloro-6,6-difluoro-[1,3]-dioxolo-[4,5f] | | |
| benzimidazole | | |
| 3-{1-[4-(2-chlorophenoxy)-5-fluoropyrimid- | 10:1 to 1:10 | 5:1 to 1:5 |
| 6-yloxy)-phenyl]-1-(methoximino)- | | |
| methyl}-5,6-di-hydro-1,4,2-dioxazine | | |
| Zoxamide | 50:1 to 1:10 | 20:1 to 1:5 |
| Cyamidazosulfamid | 20:1 to 1:5 | 20:1 to 1:5 |
| Silthiopham | 20:1 to 1:10 | 20:1 to 1:5 |
| Trifloxystrobin | 10:1 to 1:10 | 5:1 to 1:5 |
| N-methyl-2-(methoxyimino)-2-[2-([1-(3- | 10:1 to 1:10 | 5:1 to 1:5 |
| trifluoro-methylphenyl)-ethoxy]- | | |
| iminomethyl)-phenyl]-acetamide | | |
| 2-[2-([2-phenyl-2-methoxyimino-1- | 10:1 to 1:10 | 5:1 to 1:5 |
| methylethyl]iminooxymethyl)phenyl]- | | |
| 2-methoxyimino-N-methylacetamide | | |
| 2-[2-([2-(4-fluorophenyl)-2-methoxyimino-1- | 10:1 to 1:10 | 5:1 to 1:5 |
| methylethyl]iminooxymethyl)phenyl]-2- | | |
| methoxy-imino-N-methylacetamide | | |
| 2-[4-methoxy-3-(1-methylethoxy)-1,4- | 10:1 to 1:10 | 5:1 to 1:5 |
| diazabuta-1,3-dienyloxymethyl]phenyl-2- | | |
| methoximino-N-methylacetamide | | |
| methyl N-(2-[1-(4-chlorophenyl)pyrazol- | 10:1 to 1:10 | 5:1 to 1:5 |
| 3-yloxy-methyl]phenyl)-N-methoxy- | | |
| carbamate | | |
| 2,4-dihydro-5-methoxy-2-methyl- | 10:1 to 1:10 | 5:1 to 1:5 |
| 4-[2-([([1-(3-trifluoromethyl-phenyl)- | | |
| ethylidene]-amino)-oxy]-methyl)phenyl]-3H- | | |
| 1,2,4-triazol-3-one | | |
| Benomyl | 10:1 to 1:10 | 5:1 to 1:5 |

The active compound combinations according to the invention have very good fungicidal properties and can be employed for controlling phytopathogenic fungi, such as Plasmodiophoromycetes, Oomycetes, Chytridiomycetes, Zygomycetes, Ascomycetes, Basidiomycetes, Deuteromycetes, etc.

The active compound combinations according to the invention are particularly suitable for controlling Phytophthora infestans and Plasmopara viticola.

The fact that the active compound combinations are well tolerated by plants at the concentrations required for controlling plant diseases permits the treatment of above-ground parts of plants, of propagation stock and seeds, and of the soil. The active compound combinations according to the invention can be employed for foliar application or else as seed dressings.

The active compound combinations according to the invention may also be employed to increase the yield of crops. However, they have reduced toxicity and are tolerated well by plants.

According to the invention, it is possible to treat all plants and parts of plants. Plants are to be understood here as meaning all plants and plant populations such as desired and undesired wild plants or crop plants (including naturally occurring crop plants). Crop plants can be plants which can be obtained by conventional breeding and optimization methods or by biotechnological and genetic engineering methods or combinations of these methods, including the transgenic plants and including the plant cultivars which can or cannot be protected by plant breeder's certificates. Parts of plants are to be understood as meaning all above-ground and below-ground parts and organs of plants, such as shoot, leaf, flower and root, examples which may be mentioned being leaves, needles, stems, trunks, flowers, fruit-bodies, fruits and seeds and also roots, tubers and rhizomes. Parts of plants also include harvested plants and vegetative and generative propagation material, for example seedlings, tubers, rhizomes, cuttings and seeds.

The treatment of the plants and parts of plants according to the invention with the active compounds is carried out directly or by action on their environment, habitat or storage area according to customary treatment methods, for example by dipping, spraying, evaporating, atomizing, broadcasting, brushing-on and, in the case of propagation material, in particular in the case of seeds, furthermore by one- or multi-layer coating.

As already mentioned above, it is possible to treat all plants and their parts according to the invention. In a preferred embodiment, wild plant species and plant varieties, or those obtained by conventional biological breeding methods, such as crossing or protoplast fusion, and parts thereof, are treated. In a further preferred embodiment, transgenic plants and plant varieties obtained by genetic engineering, if appropriate in combination with conventional methods (Genetic Modified Organisms), and parts thereof are treated. The term “parts” or “parts of plants” or “plant parts” has been explained above.

Particularly preferably, plants of the plant varieties which are in each case commercially available or in use are treated according to the invention. Plant varieties are to be understood as meaning plants having certain properties (traits) which may have been obtained by conventional breeding, by mutagenesis or by recombinant DNA techniques. These can be varieties, bio- or genotypes.

Depending on the plant species or plant varieties, their location and growth conditions (soils, climate, vegetation period, diet), the treatment according to the invention may also result in superadditive (“synergistic”) effects. Thus, for example, reduced application rates and/or a widening of the activity spectrum and/or an increase in the activity of the substances and compositions which can be used according to the invention, better plant growth, increased tolerance to high or low temperatures, increased tolerance to drought or to water or soil salt content, increased flowering performance, easier harvesting, accelerated maturation, higher harvest yields, better quality and/or a higher nutritional value of the harvested products, better storage stability and/or processability of the harvested products are possible which exceed the effects which were actually to be expected.

The transgenic plants or plant varieties (i.e. those obtained by genetic engineering) which are preferred and to be treated according to the invention include all plants which, in the genetic modification, received genetic material which imparts particularly advantageous useful traits to these plants. Examples of such properties are better plant growth, increased tolerance to high or low temperatures, increased tolerance to drought or to water or soil salt content, increased flowering performance, easier harvesting, accelerated maturation, higher harvest yields, better quality and/or a higher nutritional value of the harvested products, better storage stability and/or processability of the harvested products. Further and particularly emphasized examples of such properties are a better defence of the plants against animal and microbial pests, such as against insects, mites, phytopathogenic fungi, bacteria and/or viruses, and also increased tolerance of the plants to certain herbicidally active compounds. Examples of transgenic plants which may be mentioned are the important crop plants, such as cereals (wheat, rice), maize, soya beans, potatoes, cotton, oilseed rape and also fruit plants (with the fruits apples, pears, citrus fruits and grapes), and particular emphasis is given to maize, soya beans, potatoes, cotton and oilseed rape. Traits that are particularly emphasized are the increased defence of the plants against insects by toxins formed in the plants, in particular those formed by the genetic material from Bacillus thuringiensis (for example by the genes CryIA(a), CryIA(b), CryIA(c), CryIIA, CryIIIA, CryIIIB2, Cry9c Cry2Ab, Cry3Bb and CryIF and also combinations thereof) (hereinbelow referred to as “Bt plants”). Traits that are also particularly emphasized are the increased defence of plants against fungi, bacteria and viruses by systemically acquired resistance (SAR), systemin, phytoalexins, elicitors and resistance genes and correspondingly expressed proteins and toxins. Traits that are furthermore particularly emphasized are the increased tolerance of the plants to certain herbicidally active compounds, for example imidazolinones, sulphonylureas, glyphosate or phosphinotricin (for example the “PAT” gene). The genes which impart the desired traits in question can also be present in combination with one another in the transgenic plants. Examples of “Bt plants” which may be mentioned are maize varieties, cotton varieties, soya bean varieties and potato varieties which are sold under the trade names YIELD GARD® (for example maize, cotton, soya beans), KnockOut® (for example maize), StarLink® (for example maize), Bollgard® (cotton), Nucotn® (cotton) and NewLeaf® (potato). Examples of herbicide-tolerant plants which may be mentioned are maize varieties, cotton varieties and soya bean varieties which are sold under the trade names Roundup Ready® (tolerance to glyphosate, for example maize, cotton, soya bean), Liberty Link® (tolerance to phosphinotricin, for example oilseed rape), IMI® (tolerance to imidazolinones) and STS® (tolerance to sulphonylureas, for example maize). Herbicide-resistant plants (plants bred in a conventional manner for herbicide tolerance) which may be mentioned include the varieties sold under the name Clearfield® (for example maize). Of course, these statements also apply to plant varieties having these or still-to-be-developed genetic traits, which plants will be developed and/or marketed in the future.

The plants listed can be treated according to the invention in a particularly advantageous manner with the compounds of the general formula I and/or the active compound mixtures according to the invention. The preferred ranges stated above for the active compounds and/or mixtures also apply to the treatment of these plants. Particular emphasis is given to the treatment of plants with the compounds and/or mixtures specifically mentioned in the present text.

The active compound combinations according to the invention can be converted to the customary formulations, such as solutions, emulsions, suspensions, powders, foams, pastes, granules, aerosols and microencapsulations in polymeric substances and in coating compositions for seeds, and ULV formulations.

These formulations are produced in a known manner, for example by mixing the active compounds or active compound combinations with extenders, that is liquid solvents, liquefied gases under pressure, and/or solid carriers, optionally with the use of surfactants, that is emulsifiers and/or dispersants, and/or foam formers. If the extender used is water, it is also possible to use, for example, organic solvents as auxiliary solvents. Essentially, suitable liquid solvents include: aromatics such as xylene, toluene or alkylnaphthalenes, chlorinated aromatics or chlorinated aliphatic hydrocarbons such as chlorobenzenes, chloroethylenes or methylene chloride, aliphatic hydrocarbons such as cyclohexane or paraffins, for example petroleum fractions, alcohols such as butanol or glycol and their ethers and esters, ketones such as acetone, methyl ethyl ketone, methyl isobutyl ketone or cyclohexanone, strongly polar solvents such as dimethylformamide and dimethyl sulphoxide, or else water. Liquefied gaseous extenders or carriers are to be understood as meaning liquids which are gaseous at ambient temperature and under atmospheric pressure, for example aerosol propellants such as butane, propane, nitrogen and carbon dioxide. Suitable solid carriers are: for example ground natural minerals such as kaolins, clays, talc, chalk, quartz, attapulgite, montmorillonite or diatomaceous earth, and ground synthetic minerals such as finely divided silica, alumina and silicates. Suitable solid carriers for granules are: for example crushed and fractionated natural rocks such as calcite, marble, pumice, sepiolite and dolomite, or else synthetic granules of inorganic and organic meals, and granules of organic material such as sawdust, coconut shells, maize cobs and tobacco stalks. Suitable emulsifiers and/or foam formers are: for example nonionic and anionic emulsifiers, such as polyoxyethylene fatty acid esters, polyoxyethylene fatty alcohol ethers, for example alkylaryl polyglycol ethers, alkylsulphonates, alkyl sulphates, arylsulphonates, or else protein hydrolysates. Suitable dispersants are: for example lignin-sulphite waste liquors and methylcellulose.

Tackifiers such as carboxymethylcellulose and natural and synthetic polymers in the form of powders, granules or latices, such as gum arabic, polyvinyl alcohol and polyvinyl acetate, or else natural phospholipids such as cephalins and lecithins and synthetic phospholipids can be used in the formulations. Other additives can be mineral and vegetable oils.

It is possible to use colorants such as inorganic pigments, for example iron oxide, titanium oxide and Prussian Blue, and organic dyestuffs such as alizarin dyestuffs, azo dyestuffs and metal phthalocyanine dyestuffs, and trace nutrients such as salts of iron, manganese, boron, copper, cobalt, molybdenum and zinc.

The formulations generally comprise between 0.1 and 95% by weight of active compounds, preferably between 0.5 and 90%.

The active compound combinations according to the invention, as such or in their formulations, can also be applied in a mixture with known fungicides, bactericides, acaricides, nematicides or insecticides, to broaden the activity spectrum or to prevent the development of resistance, for example. In many cases, synergistic effects are obtained, i.e. the activity of the mixture is greater than the activity of the individual components.

A mixture with other known active compounds such as herbicides or with fertilizers and growth regulators is also possible.

The active compound combinations can be used as such, in the form of their formulations or as the use forms prepared therefrom, such as ready-to-use solutions, emulsifiable concentrates, emulsions, suspensions, wettable powders, soluble powders and granules. They are used in the customary manner, for example by watering, spraying, atomizing, scattering, spreading, and as a powder for dry seed treatment, a solution for seed treatment, a water-soluble powder for seed treatment, a water-soluble powder for slurry treatment, or by encrusting.

When using the active compound combinations according to the invention, the application rates can be varied within a relatively wide range, depending on the kind of application. In the treatment of parts of plants, the application rates of active compound combination are generally between 0.1 and 10 000 g/ha, preferably between 10 and 1 000 g/ha. In the treatment of seeds, the application rates of active compound combination are generally between 0.001 and 50 g per kilogram of seed, preferably between 0.01 and 10 g per kilogram of seed. In the treatment of the soil, the application rates of active compound combination are generally between 0.1 and 10 000 g/ha, preferably between 1 and 5 000 g/ha.

The good fungicidal activity of the active compound combinations according to the invention is evident from the examples below. While the individual active compounds exhibit weaknesses with regard to fungicidal activity, the combinations have an activity which exceeds the sum of individual activities. However, the invention is not limited to the examples.

### EXAMPLE 1

Erysiphe Test (Barley)/Protective

| | | |
|---|---|---|
| Solvent: | 25 | parts by weight of N,N-dimethylacetamide |
| Emulsifier: | 0.6 | parts by weight of alkylaryl polyglycol ether |

To produce a suitable preparation of active compound, 1 part by weight of active compound or active compound combination is mixed with the stated amounts of solvent and emulsifier, and the concentrate is diluted with water to the desired concentration.

To test for protective activity, young plants are sprayed with the preparation of active compound at the stated application rate.

After the spray coating has dried on, the plants are dusted with spores of Erysiphe graminis f.sp. hordei.

The plants are placed in a greenhouse at a temperature of approximately 20° C. and a relative atmospheric humidity of approximately 80% to promote the development of mildew postules.

Evaluation is carried out 7 days after the inoculation. 0% means an efficacy which corresponds to that of the control, whereas an efficacy of 100% means that no infection is observed.

TABLE 1
Erysiphe test (barley)/protective

| | Application rate | |
|---|---|---|
| | of active | |
| | compound | Efficacy |
| Active compound | in g/ha | in % |
| Known: | | |
| Compound of the formula (I) | 12.5 | 80 |
| Compound of the formula (LXX) (69) | 12.5 | 90 |
| Compound of the formula (LXXI) (70) | 12.5 | 0 |
| Compound of the formula (LXXII) (71) | 12.5 | 0 |
| cyprodinil (XVIII) (17) | 12.5 | 0 |
| imidacloprid (XXIV) (23) | 12.5 | 0 |
| fludioxonil (XXX) (29) | 12.5 | 0 |
| pencycuron (XXXVIII) (37) | 12.5 | 50 |
| Mixtures according to the invention: | | |
| (I) + (LXX) (69) | 6.25 + 6.25 | 100 |
| (I) + (LXXI) (70) | 6.25 + 6.25 | 95 |
| (I) + (LXXII) (71) | 6.25 + 6.25 | 100 |
| (I) + cyprodinil (XVIII) (17) | 6.25 + 6.25 | 100 |
| (I) + imidacloprid (XXIV) (23) | 6.25 + 6.25 | 100 |
| (I) + fludioxonil (XXX) (29) | 6.25 + 6.25 | 100 |
| (I) + pencycuron (XXXVIII) (37) | 6.25 + 6.25 | 100 |

### EXAMPLE 2

Erysiphe Test (Wheat)/Protective

| | | |
|---|---|---|
| Solvent: | 25 | parts by weight of N,N-dimethylacetamide |
| Emulsifier: | 0.6 | part by weight of alkylaryl polyglycol ether |

To produce a suitable preparation of active compound, 1 part by weight of active compound or active compound combination is mixed with the stated amounts of solvent and emulsifier, and the concentrate is diluted with water to the desired concentration.

To test for protective activity, young plants are sprayed with the preparation of active compound at the stated application rate.

After the spray coating has dried on, the plants are dusted with spores of Erysiphe graminis f.sp. tritici.

The plants are placed in a greenhouse at a temperature of approximately 20° C. and a relative atmospheric humidity of approximately 80% to promote the development of mildew postules.

Evaluation is carried out 7 days after the inoculation. 0% means an efficacy which corresponds to that of the control, whereas an efficacy of 100% means that no infection is observed.

TABLE 2
Erysiphe test (wheat)/protective

| | Application rate | |
|---|---|---|
| | of active | |
| | compound | |
| Active compound | in g/ha | Efficacy in % |
| Known: | | |
| Compound of the formula (I) | 6.25 | 0 |
| epoxiconazole (XI) (10) | 6.25 | 70 |
| metconazole (XII) (11) | 6.25 | 50 |
| Mixtures according to the invention: | | |
| (I) + epoxiconazole (XI) (10) | 3.125 + 3.125 | 100 |
| (I) + metconazole (XII) (11) | 3.125 + 3.125 | 70 |

### EXAMPLE 3

Leptosphaeria nodorum Test (Wheat)/Protective

| | | |
|---|---|---|
| Solvent: | 25 | parts by weight of N,N-dimethylacetamide |
| Emulsifier: | 0.6 | part by weight of alkylaryl polyglycol ether |

To produce a suitable preparation of active compound, 1 part by weight of active compound or active compound combination is mixed with the stated amounts of solvents and emulsifier, and the concentrate is diluted with water to the desired concentration.

To test for protective activity, young plants are sprayed with the preparation of active compound at the stated application rate. After the spray coating has dried on, the plants are sprayed with a spore suspension of Leptosphaeria nodorum. The plants remain in an incubation cabin at 20° C. and 100% relative atmospheric humidity for 48 hours.

The plants are placed in a greenhouse at a temperature of approximately 15° C. and a relative atmospheric humidity of 80%.

Evaluation is carried out 10 days after the inoculation. 0% means an efficacy which corresponds to that of the control, whereas an efficacy of 100% means that no infection is observed.

TABLE 3
Leptosphaeria nodorum test (wheat)/protective

| | Application rate | |
|---|---|---|
| | of active | |
| | compound | Efficacy |
| Active compound | in g/ha | in % |
| Known: | | |
| Compound of the formula (I) | 25 | 60 |
| Compound of the formula (LXXI) (70) | 25 | 0 |
| Compound of the formula (LXXII) (71) | 25 | 40 |
| tebuconazole (IV) (3) | 25 | 50 |
| Mixtures according to the invention: | | |
| (I) + (LXXI) (70) | 12.5 + 12.5 | 80 |
| (I) + tebuconazole (IV) (3) | 12.5 + 12.5 | 80 |
| (I) + (LXXII) (71) | 12.5 + 12.5 | 80 |

### EXAMPLE 4

Pyrenophora teres Test (Barley)/Protective

| | | |
|---|---|---|
| Solvent: | 25 | parts by weight of N,N-dimethylacetamide |
| Emulsifier: | 0.6 | part by weight of alkylaryl polyglycol ether |

To produce a suitable preparation of active compound, 1 part by weight of active compound or active compound combination is mixed with the stated amounts of solvent and emulsifier, and the concentrate is diluted with water to the desired concentration.

To test for protective activity, young plants are sprayed with the preparation of active compound at the stated application rate. After the spray coating has dried on, the plants are sprayed with a conidia suspension of Pyrenophora teres. The plants remain in an incubation cabin at 20° C. and 100% relative atmospheric humidity for 48 hours.

The plants are then placed in a greenhouse at a temperature of approximately 20° C. and a relative atmospheric humidity of approximately 80%.

Evaluation is carried out 7 days after the inoculation. 0% means an efficacy which corresponds to that of the control, whereas an efficacy of 100% means that no infection is observed.

TABLE 4
Pyrenophora teres test (barley)/protective

| | Application rate | |
|---|---|---|
| | of active | |
| | compound | Efficacy |
| Active compound | in g/ha | in % |
| Known: | | |
| Compound of the formula (I) | 25 | 60 |
| Compound of the formula (LXX) (69) | 25 | 70 |
| epoxiconazole (XI) (10) | 25 | 60 |
| tebuconazole (IV) (3) | 25 | 0 |
| triadimenol (X) (9) | 25 | 30 |
| cyprodinil (XVIII) (17) | 25 | 0 |
| Mixtures according to the invention: | | |
| (I) + (LXX) (69) | 12.5 + 12.5 | 90 |
| (I) + epoxiconazole (XI) (10) | 12.5 + 12.5 | 90 |
| (I) + tebuconazole (IV) (3) | 12.5 + 12.5 | 80 |
| (I) + triadimenol (X) (9) | 12.5 + 12.5 | 80 |
| (I) + cyprodinil (XVIII) (17) | 12.5 + 12.5 | 90 |

### EXAMPLE 5

Phytophthora Test (Tomato)/Protective

| | | |
|---|---|---|
| Solvent: | 24.5 | parts by weight of acetone |
| | 24.5 | parts by weight of dimethylacetamide |
| Emulsifier: | 1 | part by weight of alkylaryl polyglycol ether |

To produce a suitable preparation of active compound, 1 part by weight of active compound or active compound combination is mixed with the stated amounts of solvent and emulsifier, and the concentrate is diluted with water to the desired concentration, or a commercial formulation of active compound or active compound combination is diluted with water to the desired concentration. To test for protective activity, young plants are sprayed with the preparation of active compound at the stated application rate. After the spray coating has dried on, the plants are inoculated with an aqueous spore suspension of Phytophthora infestans. The plants are then placed in an incubation cabin at approximately 20° C. and 100% relative atmospheric humidity.

Evaluation is carried out 3 days after the inoculation. 0% means an efficacy which corresponds to that of the control, whereas an efficacy of 100% means that no infection is observed.

The good fungicidal activity of the active compound combinations according to the invention is evident from the example below. While the individual active compounds exhibit weaknesses with regard to fungicidal activity, the combinations have an activity which exceeds the sum of the individual activities.

A synergistic effect of fungicides is always present when the fungicidal activity of the active compound combinations exceeds the total of the activities of the active compounds when applied individually.

The expected activity for a given combination of two active compounds can be calculated as follows according to S. R. Colby (“Calculating Synergistic and Antagonistic Responses of Herbicide Combinations”, Weeds 15 (1967), 20-22):

if

X is the efficacy when applying active compound A at an application rate of m g/ha,

Y is the efficacy when applying active compound B at an application rate of n g/ha and

E is the efficacy when applying the active compounds A and B at an application rate of m and n g/ha, respectively,

then

$$E = X + Y - \frac{X \times Y}{100}$$

The efficacy is calculated in %. 0% is an efficacy which corresponds to that of the control, whereas an efficacy of 100% means that no infection is observed.

If the actual fungicidal activity exceeds the calculated value, then the activity of the combination is superadditive, i.e. a synergistic effect exists. In this case, the efficacy which was actually observed must be greater than the value for the expected efficacy (E) calculated from the abovementioned formula.

The table below shows clearly that the observed activity of the active compound combination according to the invention is greater than the calculated activity, i.e. that a synergistic effect is present.

TABLE 5.1
Phytophthora test (tomato)/protective

| | Application rate | |
|---|---|---|
| | of active | |
| Active compound known: compound in g/ha | % Efficacy | |
| Compound of the formula (I) 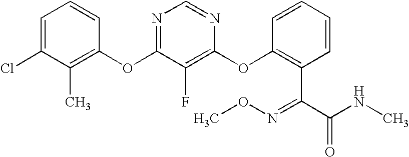 | 0.5 | 32 |
| cyamidazosulfamid (LXX IV)(73) 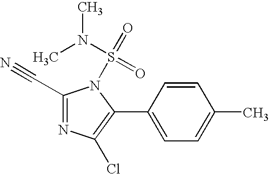 | 0.5 | 45 |

Mixture according to the invention:

| | | | Application | | | Expected value, |
|---|---|---|---|---|---|---|
| | Mixing | | rate of active | Actual | | calculated using |
| | ratio | | compound in g/ha | efficacy | | Colby's formula |
| (I) + | | | 0.5 | | | |
| cyamidazosulfamid | {close oversize brace} | 1:1 | + | {close oversize brace} | 88 | 63 |
| (LXXIV) (73) | | | 0.5 | | | |

TABLE 5.2
Phytophthora test (tomato)/protective

| | Application rate | |
|---|---|---|
| | of active | |
| Active compound known: compound in g/ha | % Efficacy | |
| Compound of the formula (I) 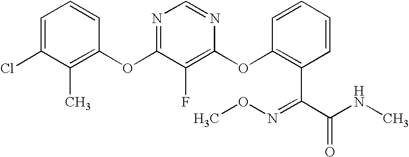 | 1 | 60 |
| triadimenol (X) (9) 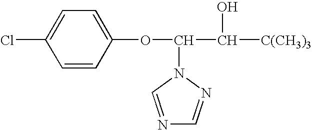 | 5 | 0 |

Mixture according to the invention:

| | | | Application | | | Expected value, |
|---|---|---|---|---|---|---|
| | Mixing | | rate of active | Actual | | calculated using |
| | ratio | | compound in g/ha | efficacy | | Colby's formula |
| (I) + | | | 1 | | | |
| triadimentol | {close oversize brace} | 1:5 | + | {close oversize brace} | 72 | 60 |
| (X) (9) | | | 5 | | | |

TABLE 5.3
Phytophthora test (tomato)/protective

| | Application rate | |
|---|---|---|
| | of active | |
| Active compound known: compound in g/ha | % Efficacy | |
| Compound of the formula (I) 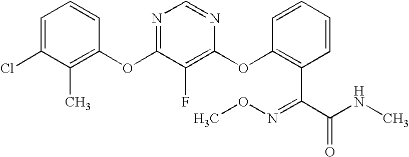 | 2 | 72 |
| captan (LV) (54) 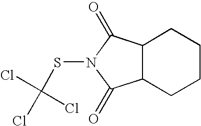 | 40 | 0 |

Mixture according to the invention:

| | | | Application | | | Expected value, |
|---|---|---|---|---|---|---|
| | Mixing | | rate of active | Actual | | calculated using |
| | ratio | | compound in g/ha | efficacy | | Colby's formula |
| (I) | | | 2 | | | |
| + | {close oversize brace} | 1:20 | + | {close oversize brace} | 85 | 72 |
| captan (LV) (54) | | | 40 | | | |

TABLE 5.4
Phytophthora test (tomato)/protective

| | Application rate | |
|---|---|---|
| | of active | |
| Active compound known: compound in g/ha | % Efficacy | |
| Compound of the formula (I) 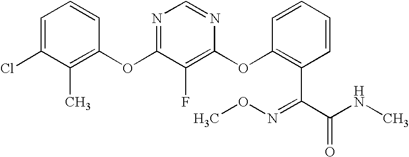 | 1 | 60 |
| dimetomorph (XLV) (44) 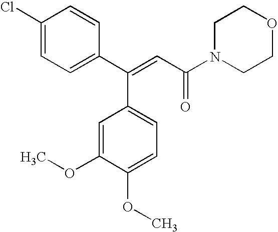 | 1 | 23 |

Mixture according to the invention:

| | | | Application | | | Expected value, |
|---|---|---|---|---|---|---|
| | Mixing | | rate of active | Actual | | calculated using |
| | ratio | | compound in g/ha | efficacy | | Colby's formula |
| (I) + | | | 1 | | | |
| dimetomorph (XLV) | {close oversize brace} | 1:1 | + | {close oversize brace} | 86 | 69 |
| (44) | | | 1 | | | |

TABLE 5.5
Phytophthora test (tomato)/protective

| | Application rate | |
|---|---|---|
| | of active | |
| Active compound known: compound in g/ha | % Efficacy | |
| Compound of the formula (I) 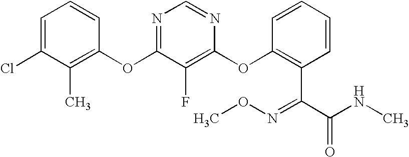 | 0.5 | 32 |
| cymoxanil (XLIV) (45) 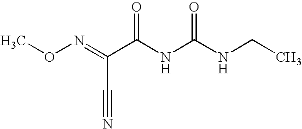 | 2.5 | 0 |

Mixture according to the invention:

| | | | Application | | | Expected value, |
|---|---|---|---|---|---|---|
| | Mixing | | rate of active | Actual | | calculated using |
| | ratio | | compound in g/ha | efficacy | | Colby's formula |
| (I) + | | | 0.5 | | | |
| cymoxanil (XLVI) | {close oversize brace} | 1.1 | + | {close oversize brace} | 87 | 32 |
| (45) | | | 2.5 | | | |

TABLE 5.6
Phytophthora test (tomato)/protective

| | Application rate | |
|---|---|---|
| | of active | |
| Active compound known: compound in g/ha | % Efficacy | |
| Compound of the formula (I) 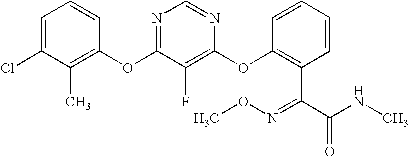 | 1 | 60 |
| fosetyl-A1 (XLVII) (46) 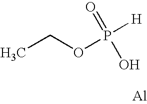 | 10 | 0 |

Mixture according to the invention:

| | | | Application | | | Expected value, |
|---|---|---|---|---|---|---|
| | Mixing | | rate of active | Actual | | calculated using |
| | ratio | | compound in g/ha | efficacy | | Colby's formula |
| (I) + | | | 1 | | | |
| fosetyl-A1 (XLVII) | {close oversize brace} | 1:10 | + | {close oversize brace} | 7 | 60 |
| (46) | | | 10 | | | |

TABLE 5.7
Phytophthora test (tomato)/protective

| | Application rate | |
|---|---|---|
| | of active | |
| Active compound known: compound in g/ha | % Efficacy | |
| Compound of the formula (I) 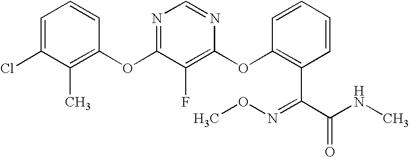 | 1 | 60 |
| kresoxim-methyl (XVI) (15) 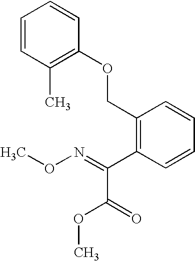 | 1 | 35 |

Mixture according to the invention:

| | | | Application | | | Expected value, |
|---|---|---|---|---|---|---|
| | Mixing | | rate of active | Actual | | calculated using |
| | ratio | | compound in g/ha | efficacy | | Colby's formula |
| (I) + | | | 1 | | | |
| cresoxim-methyl | {close oversize brace} | 1:1 | + | {close oversize brace} | 87 | 74 |
| (XVI) (15) | | | 1 | | | |

TABLE 5.8
Phytophthora test (tomato)/protective

| | Application rate | |
|---|---|---|
| | of active | |
| Active compound known: compound in g/ha | % Efficacy | |
| Compound of the formula (I) 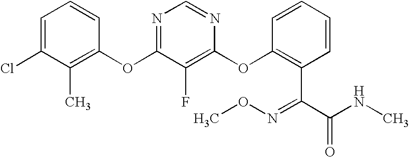 | 1 | 60 |
| (LXX) (69) 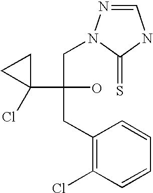 | 5 | 0 |

Mixture according to the invention:

| | | | Application | | | Expected value, |
|---|---|---|---|---|---|---|
| | Mixing | | rate of active | Actual | | calculated using |
| | ratio | | compound in g/ha | efficacy | | Colby's formula |
| (I) | | | 1 | | | |
| + | {close oversize brace} | 1:5 | + | {close oversize brace} | 73 | 60 |
| (LXX) (69) | | | 5 | | | |

TABLE 5.9
Phytophthora test (tomato)/protective

| | Application rate | |
|---|---|---|
| | of active | |
| Active compound known: compound in g/ha | % Efficacy | |
| Compound of the formula (I) 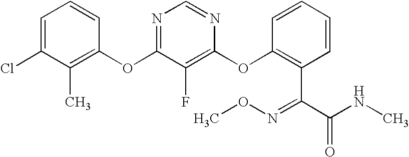 | 2 | 72 |
| spiroxamine (II) (1) 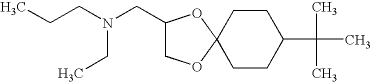 | 10 | 0 |

Mixture according to the invention:

| | | | Application | | | Expected value, |
|---|---|---|---|---|---|---|
| | Mixing | | rate of active | Actual | | calculated using |
| | ratio | | compound in g/ha | efficacy | | Colby's formula |
| (I) | | | 2 | | | |
| + | {close oversize brace} | 1:5 | + | {close oversize brace} | 90 | 72 |
| spiroxamine (II) (1) | | | 10 | | | |

TABLE 5.10
Phytophthora test (tomato)/protective

| | Application rate | |
|---|---|---|
| | of active | |
| Active compound known: compound in g/ha | % Efficacy | |
| Compound of the formula (I) 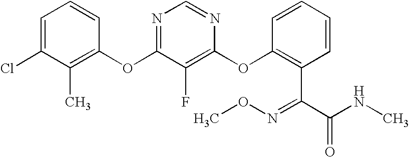 | 2 | 72 |
| mancozeb (XLIII) (42) 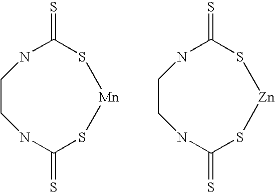 | 40 | 23 |

Mixture according to the invention:

| | | | Application | | | Expected value, |
|---|---|---|---|---|---|---|
| | Mixing | | rate of active | Actual | | calculated using |
| | ratio | | compound in g/ha | efficacy | | Colby's formula |
| (I) | | | 2 | | | |
| + | {close oversize brace} | 1:20 | + | {close oversize brace} | 91 | 78 |
| mancozeb (XLIII) (42) | | | 40 | | | |

TABLE 5.11
Phytophthora test (tomato)/protective

| | Application rate of | |
|---|---|---|
| Active compound | active compound | |
| known: | in g/ha | % Efficacy |
| 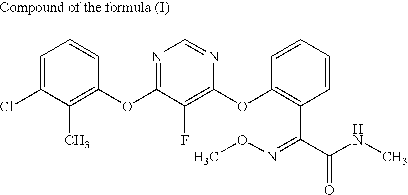 | 0.5 | 32 |
| 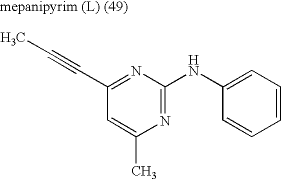 | 5 | 0 |

Mixture according to the invention:

| | | Application | | Expected value, |
|---|---|---|---|---|
| | | rate of active | | calculated |
| | Mixing | compound | Actual | using Colby's |
| | ratio | in g/ha | efficacy | formula |
| (I) +mepanipyrim (L) (49) | 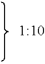 | 0.5 + 5 | 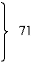 | 32 |

TABLE 5.12
Phytophthora test (tomato)/protective

| | Application rate of | |
|---|---|---|
| Active compound | active compound | |
| known: | in g/ha | % Efficacy |
| 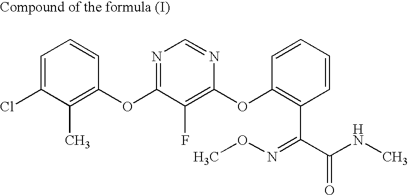 | 2 | 72 |
| 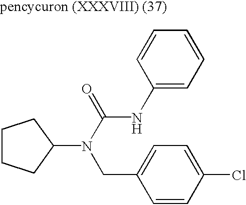 | 10 | 14 |

Mixture according to the invention:

| | | Application | | Expected value, |
|---|---|---|---|---|
| | | rate of active | | calculated |
| | Mixing | compound | Actual | using Colby's |
| | ratio | in g/ha | efficacy | formula |
| (I) +pencycuron (XXXVIII) (37) | 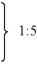 | 2 + 10 | 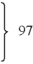 | 76 |

TABLE 5.13
Phytophthora test (tomato)/protective

| | Application rate of | |
|---|---|---|
| Active compound | active compound | |
| known: | in g/ha | % Efficacy |
| 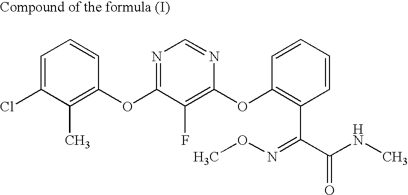 | 1 | 60 |
| 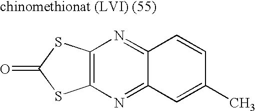 | 20 | 0 |

Mixture according to the invention:

| | | Application | | Expected value, |
|---|---|---|---|---|
| | | rate of active | | calculated |
| | Mixing | compound | Actual | using Colby's |
| | ratio | in g/ha | efficacy | formula |
| (I) +chinomethinat (LVI) (55) | 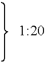 | 1 + 20 | 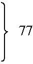 | 60 |

TABLE 5.14
Phytophthora test (tomato)/protective

| | Application rate of | |
|---|---|---|
| Active compound | active compound | |
| known: | in g/ha | % Efficacy |
| 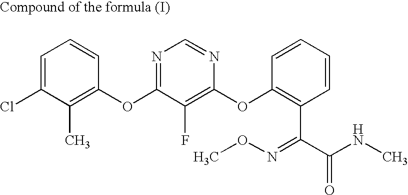 | 1 | 40 |
| 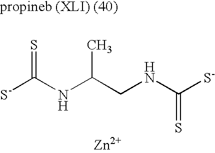 | 20 | 8 |

Mixture according to the invention:

| | | Application | | Expected value, |
|---|---|---|---|---|
| | | rate of active | | calculated |
| | Mixing | compound | Actual | using Colby's |
| | ratio | in g/ha | efficacy | formula |
| (I) +propineb (XLI) (40) | 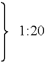 | 1 + 20 | 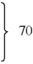 | 45 |

TABLE 5.15
Phytophthora test (tomato)/protective

| | Application rate of | |
|---|---|---|
| Active compound | active compound | |
| known: | in g/ha | % Efficacy |
| 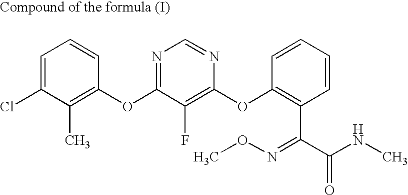 | 1 | 60 |
| 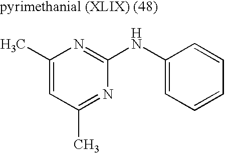 | 10 | 11 |

Mixture according to the invention:

| | | Application | | Expected value, |
|---|---|---|---|---|
| | | rate of active | | calculated |
| | Mixing | compound | Actual | using Colby's |
| | ratio | in g/ha | efficacy | formula |
| (I) +pyrimethanil (XLIX) (48) | 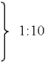 | 1 + 10 | 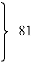 | 64 |

TABLE 5.16
Phytophthora test (tomato)/protective

| | Application rate of | |
|---|---|---|
| Active compound | active compound | |
| known: | in g/ha | % Efficacy |
| 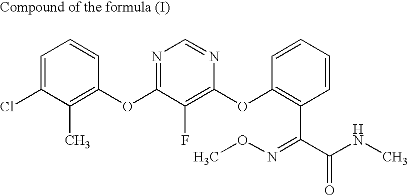 | 1 | 60 |
| 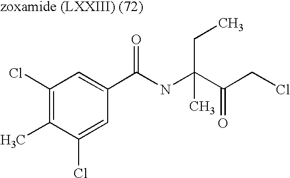 | 1 | 19 |

Mixture according to the invention:

| | | Application | | Expected value, |
|---|---|---|---|---|
| | | rate of active | | calculated |
| | Mixing | compound | Actual | using Colby's |
| | ratio | in g/ha | efficacy | formula |
| (I) +zoxamide (LXXIII) (72) | 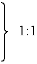 | 1 + 1 | 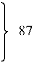 | 68 |

TABLE 5.17
Phytophthora test (tomato)/protective

| | Application rate of | |
|---|---|---|
| Active compound | active compound | |
| known: | in g/ha | % Efficacy |
| 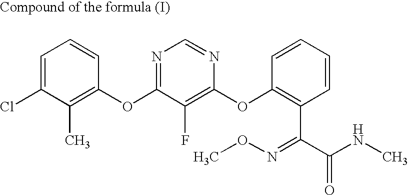 | 0.5 | 32 |
| 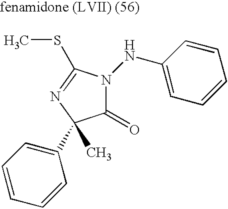 | 0.5 | 48 |

Mixture according to the invention:

| | | Application | | Expected value, |
|---|---|---|---|---|
| | | rate of active | | calculated |
| | Mixing | compound | Actual | using Colby's |
| | ratio | in g/ha | efficacy | formula |
| (I) +fenamidone (LVII) (56) | 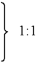 | 0.5 + 0.5 | 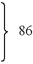 | 65 |

TABLE 5.18
Phytophthora test (tomato)/protective

| | Application rate of | |
|---|---|---|
| Active compound | active compound | |
| known: | in g/ha | % Efficacy |
| 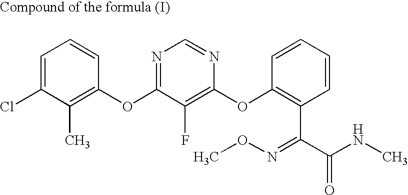 | 0.5 | 32 |
| sulphur (LXII) (62) | 25 | 0 |

Mixture according to the invention:

| | | Application | | Expected value, |
|---|---|---|---|---|
| | | rate of active | | calculated |
| | Mixing | compound | Actual | using Colby's |
| | ratio | in g/ha | efficacy | formula |
| (I) +sulphur (LXIII) (62) | 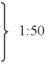 | 0.5 + 25 | 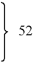 | 32 |

TABLE 5.19
Phytophthora test (tomato)/protective

| | Application rate of | |
|---|---|---|
| Active compound | active compound | |
| known: | in g/ha | % Efficacy |
| 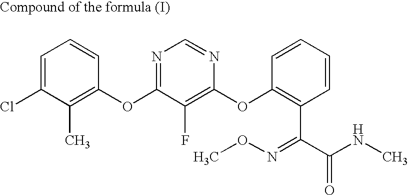 | 1 | 60 |
| 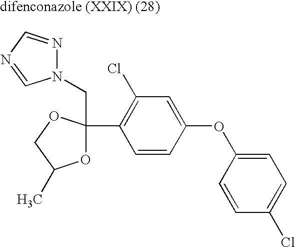 | 5 | 5 |

Mixture according to the invention:

| | | Application | | Expected value, |
|---|---|---|---|---|
| | | rate of active | | calculated |
| | Mixing | compound | Actual | using Colby's |
| | ratio | in g/ha | efficacy | formula |
| (I) +difenconazole (XXIX) (28) | 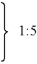 | 1 + 5 | 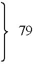 | 62 |

TABLE 5.20
Phytophthora test (tomato)/protective

| | Application rate of | |
|---|---|---|
| Active compound | active compound | |
| known: | in g/ha | % Efficacy |
| 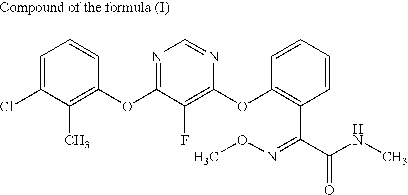 | 0.5 | 32 |
| 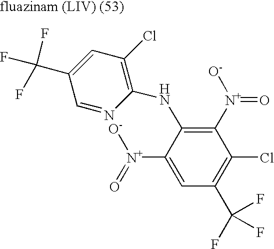 | 2.5 | 32 |

Mixture according to the invention:

| | | Application | | Expected value, |
|---|---|---|---|---|
| | | rate of active | | calculated |
| | Mixing | compound | Actual | using Colby's |
| | ratio | in g/ha | efficacy | formula |
| (I) +fluazinam (LIV) (53) | 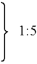 | 0.5 + 2.5 | 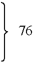 | 54 |

TABLE 5.21
Phytophthora test (tomato)/protective

| | Application rate | |
|---|---|---|
| | of active | |
| Active compound known: compound in g/ha | % Efficacy | |
| Compound of the formula (I) 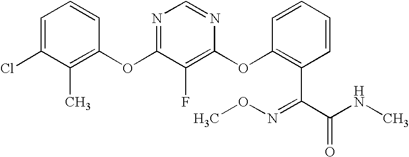 | 2 | 72 |
| prochloraz (XXI) (20) 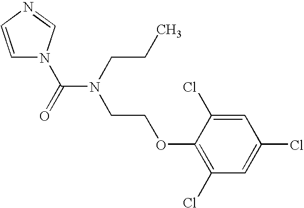 | 10 | 0 |

Mixture according to the invention:

| | | | Application | | | Expected value, |
|---|---|---|---|---|---|---|
| | Mixing | | rate of active | Actual | | calculated using |
| | ratio | | compound in g/ha | efficacy | | Colby's formula |
| (I) | | | 2 | | | |
| + | {close oversize brace} | 1:5 | + | {close oversize brace} | 87 | 72 |
| prochloraz (XXI) (20) | | | 10 | | | |

TABLE 5.22
Phytophthora test (tomato)/protective

| | Application rate | |
|---|---|---|
| | of active | |
| Active compound known: compound in g/ha | % Efficacy | |
| Compound of the formula (I) 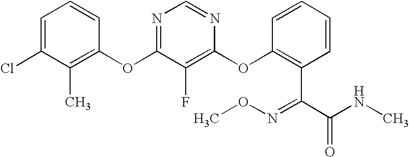 | 0.5 | 32 |
| iprovalicarb (LI) (50) 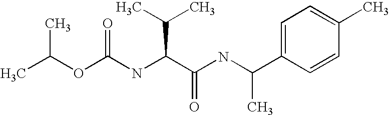 | 0.5 | 2 |

Mixture according to the invention:

| | | | Application | | | Expected value, |
|---|---|---|---|---|---|---|
| | Mixing | | rate of active | Actual | | calculated using |
| | ratio | | compound in g/ha | efficacy | | Colby's formula |
| (I) | | | 0.5 | | | |
| + | {close oversize brace} | 1:1 | + | {close oversize brace} | 62 | 33 |
| iprovalicarb (LI) (50) | | | 0.5 | | | |

### EXAMPLE G

Sphaerotheca Test (Cucumber)/Protective

Sphaerotheca test (cucumber)/protective

| | |
|---|---|
| Solvent: | 24.5 parts by weight of acetone |
| | 24.5 parts by weight of dimethylacetamide |
| Emulsifier: | 1 part by weight of alkylaryl polyglycol ether |

To produce a suitable preparation of active compound, 1 part by weight of active compound or active compound combination is mixed with the stated amounts of solvent and emulsifier, and the concentrate is diluted with water to the desired concentration, or a commercial formulation of active compound or active compound combination is diluted with water to the desired concentration.

To test for protective activity, young plants are sprayed with the preparation of active compound at the stated application rate. After the spray coating has dried on, the plants are inoculated with an aqueous spore suspension of Sphaerotheca fuliginea. The plants are then placed in a greenhouse at approximately 23° C. and a relative atmospheric humidity of approximately 70%.

Evaluation is carried out 10 days after the inoculation. 0% means an efficacy which corresponds to that of the control, whereas an efficacy of 100% means that no infection is observed.

The good fungicidal activity of the active compound combinations according to the invention is evident from the example below. While the individual active compounds exhibit weaknesses with regard to fungicidal activity, the combinations have an activity which exceeds the sum of the individual activities.

A synergistic effect of fungicides is always present when the fungicidal activity of the active compound combinations exceeds the total of the activities of the active compounds when applied individually.

The expected activity for a given combination of two active compounds can be calculated as follows according to S.R. Colby (“Calculating Synergistic and Antagonistic Responses of Herbicide Combinations”, Weeds 15 (1967), 20-22):

if

X is the efficacy when applying active compound A at an application rate of m g/ha,

Y is the efficacy when applying active compound B at an application rate of n g/ha and

E is the efficacy when applying the active compounds A and B at an application rate of m and n g/ha, respectively,

then

$$E = X + Y - \frac{X \times Y}{100}$$

The efficacy is calculated in %. 0% is an efficacy which corresponds to that of the control, whereas an efficacy of 100% means that no infection is observed.

If the actual fungicidal activity exceeds the calculated value, then the activity of the combination is superadditive, i.e. a synergistic effect exists. In this case, the efficacy which was actually observed must be greater than the value for the expected efficacy (E) calculated from the abovementioned formula.

The table below shows clearly that the observed activity of the active compound combination according to the invention is greater than the calculated activity, i.e. that a synergistic effect is present.

TABLE 6.1
Sphaerotheca test (cucumber)/protective

| | Application rate | |
|---|---|---|
| | of active | |
| Active compound known: compound in g/ha | % Efficacy | |
| Compound of the formula (I) 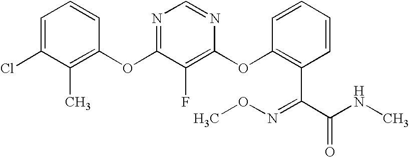 | 1 | 69 |
| cyamidazosulfamid (LXXIV) (73) 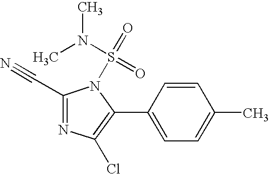 | 1 | 0 |

Mixture according to the invention:

| | | | Application | | | Expected value, |
|---|---|---|---|---|---|---|
| | Mixing | | rate of active | Actual | | calculated using |
| | ratio | | compound in g/ha | efficacy | | Colby's formula |
| (I) + | | | 1 | | | |
| cyamidazosulfamid | {close oversize brace} | 1:1 | + | {close oversize brace} | 80 | 69 |
| (LXXIV) (73) | | | 1 | | | |

TABLE 6.2
Sphaerotheca test (cucumber)/protective

| | Application rate | |
|---|---|---|
| | of active | |
| Active compound known: compound in g/ha | % Efficacy | |
| Compound of the formula (I) 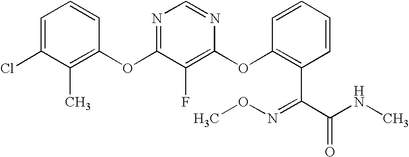 | 1 | 69 |
| (LXXXI) (70) 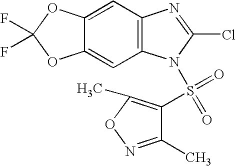 | 1 | 0 |

Mixture according to the invention:

| | | | Application | | | Expected value, |
|---|---|---|---|---|---|---|
| | Mixing | | rate of active | Actual | | calculated using |
| | ratio | | compound in g/ha | efficacy | | Colby's formula |
| (I) | | | 1 | | | |
| + | {close oversize brace} | 1:1 | + | {close oversize brace} | 93 | 69 |
| (LXXI)(70) | | | 1 | | | |

TABLE 6.3
Sphaerotheca test (cucumber)/protective

| | Application rate | |
|---|---|---|
| | of active | |
| Active compound known: compound in g/ha | % Efficacy | |
| Compound of the formula (I) 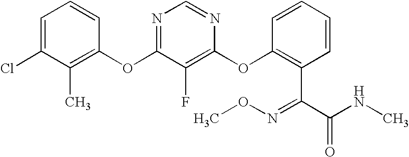 | 2 | 82 |
| triadimefon (IX) (8) 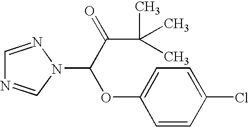 | 10 | 0 |

Mixture according to the invention:

| | | | Application | | | Expected value, |
|---|---|---|---|---|---|---|
| | Mixing | | rate of active | Actual | | calculated using |
| | ratio | | compound in g/ha | efficacy | | Colby's formula |
| (I) | | | 2 | | | |
| + | {close oversize brace} | 1:5 | + | {close oversize brace} | 93 | 82 |
| triadimefon (IX) (8) | | | 10 | | | |

TABLE 6.4
Sphaerotheca test (cucumber)/protective

| | Application rate | |
|---|---|---|
| | of active | |
| Active compound known: compound in g/ha | % Efficacy | |
| Compound of the formula (I) 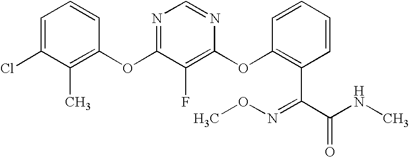 | 0.5 | 30 |
| triadimenol (X) (9) 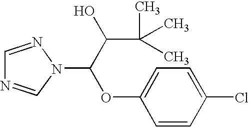 | 2.5 | 0 |

Mixture according to the invention:

| | | | Application | | | Expected value, |
|---|---|---|---|---|---|---|
| | Mixing | | rate of active | Actual | | calculated using |
| | ratio | | compound in g/ha | efficacy | | Colby's formula |
| (I) | | | 1.5 | | | |
| + | {close oversize brace} | 1:5 | + | {close oversize brace} | 57 | 30 |
| triadimenol (IX) (9) | | | 2.5 | | | |

TABLE 6.5
Sphaerotheca test (cucumber)/protective

| | Application rate | |
|---|---|---|
| | of active | |
| Active compound known: compound in g/ha | % Efficacy | |
| Compound of the formula (I) 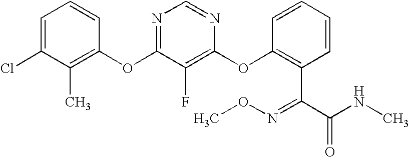 | 0.5 | 30 |
| carbendazim (XXXI) (30) 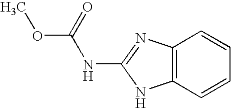 | 2.5 | 63 |

Mixture according to the invention:

| | | | Application | | | Expected value, |
|---|---|---|---|---|---|---|
| | Mixing | | rate of active | Actual | | calculated using |
| | ratio | | compound in g/ha | efficacy | | Colby's formula |
| (I) + | | | 0.5 | | | |
| carbendazim (XXXI) | {close oversize brace} | 1:5 | + | {close oversize brace} | 95 | 74 |
| (30) | | | 2.5 | | | |

TABLE 6.6
Sphaerotheca test (cucumber)/protective

| | Application rate | |
|---|---|---|
| | of active | |
| Active compound known: compound in g/ha | % Efficacy | |
| Compound of the formula (I) 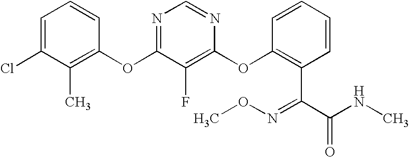 | 1 | 69 |
| benomyl (LXXXIII) (30) 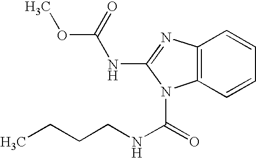 | 5 | 50 |

Mixture according to the invention:

| | | | Application | | | Expected value, |
|---|---|---|---|---|---|---|
| | Mixing | | rate of active | Actual | | calculated using |
| | ratio | | compound in g/ha | efficacy | | Colby's formula |
| (I) + | | | 1 | | | |
| benomyl (LXXXIII) | {close oversize brace} | 1:5 | + | {close oversize brace} | 95 | 85 |
| (82) | | | 5 | | | |

TABLE 6.7
Sphaerotheca test (cucumber)/protective

| | Application rate | |
|---|---|---|
| | of active | |
| Active compound known: compound in g/ha | % Efficacy | |
| Compound of the formula (I) 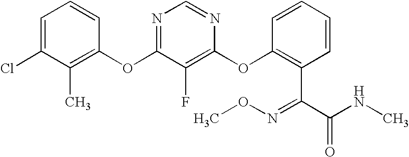 | 0.5 | 30 |
| (XIX) (18) 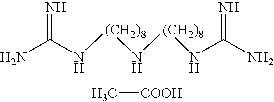 | 2.5 | 43 |

Mixture according to the invention:

| | | | Application | | | Expected value, |
|---|---|---|---|---|---|---|
| | Mixing | | rate of active | Actual | | calculated using |
| | ratio | | compound in g/ha | efficacy | | Colby's formula |
| (I) | | | 0.5 | | | |
| + | {close oversize brace} | 1:5 | + | {close oversize brace} | 97 | 60 |
| (XIX) (18) | | | 2.5 | | | |

TABLE 6.8
Sphaerotheca test (cucumber)/protective

| | Application rate | |
|---|---|---|
| | of active | |
| Active compound known: compound in g/ha | % Efficacy | |
| Compound of the formula (I) 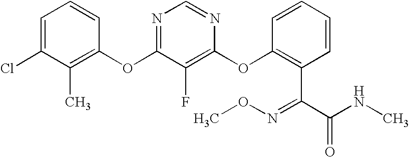 | 1 | 69 |
| Dimetomorph (XLV) (44) 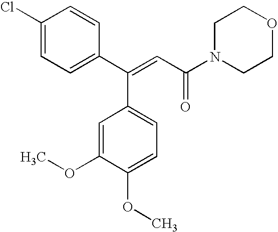 | 1 | 0 |

Mixture according to the invention:

| | | | Application | | | Expected value, |
|---|---|---|---|---|---|---|
| | Mixing | | rate of active | Actual | | calculated using |
| | ratio | | compound in g/ha | efficacy | | Colby's formula |
| (I) + | | | 1 | | | |
| dimetomorph (XLV) | {close oversize brace} | 1:1 | + | {close oversize brace} | 80 | 69 |
| (44) | | | 1 | | | |

TABLE 6.9
Sphaerotheca test (cucumber)/protective

| | Application rate | |
|---|---|---|
| | of active | |
| Active compound known: compound in g/ha | % Efficacy | |
| Compound of the formula (I) 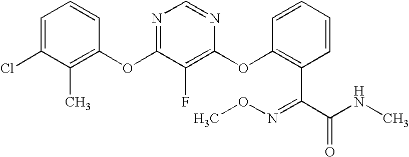 | 1 | 69 |
| cymoxanil (XLVI) (45) 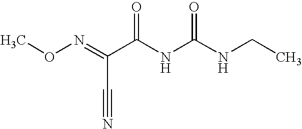 | 5 | 15 |

Mixture according to the invention:

| | | | Application | | | Expected value, |
|---|---|---|---|---|---|---|
| | Mixing | | rate of active | Actual | | calculated using |
| | ratio | | compound in g/ha | efficacy | | Colby's formula |
| (I) | | | 1 | | | |
| + | {close oversize brace} | 1:5 | + | {close oversize brace} | 93 | 74 |
| cymoxanil (XLVI) (45) | | | 5 | | | |

TABLE 6.10
Sphaerotheca test (cucumber)/protective

| | Application rate | |
|---|---|---|
| | of active | |
| Active compound known: compound in g/ha | % Efficacy | |
| Compound of the formula (I) 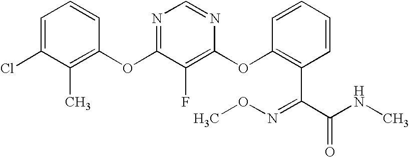 | 1 | 69 |
| Cyprodinil (XVIII) (17) 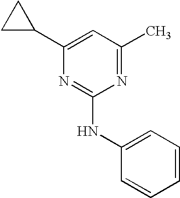 | 10 | 22 |

Mixture according to the invention:

| | | | Application | | | Expected value, |
|---|---|---|---|---|---|---|
| | Mixing | | rate of active | Actual | | calculated using |
| | ratio | | compound in g/ha | efficacy | | Colby's formula |
| (I) | | | 1 | | | |
| + | {close oversize brace} | 1:10 | + | {close oversize brace} | 93 | 76 |
| cyprodinil (XVIII) (17) | | | 10 | | | |

TABLE 6.11
Sphaerotheca test (cucumber)/protective

| | Application rate | |
|---|---|---|
| | of active | |
| Active compound known: compound in g/ha | % Efficacy | |
| Compound of the formula (I) 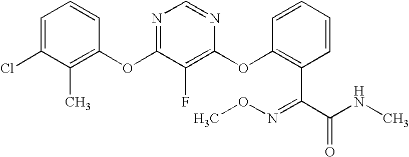 | 0.5 | 30 |
| fenpiclonil (XXVIII) (27) 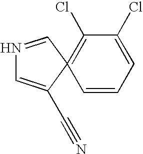 | 2.5 | 0 |

Mixture according to the invention:

| | | | Application | | | Expected value, |
|---|---|---|---|---|---|---|
| | Mixing | | rate of active | Actual | | calculated using |
| | ratio | | compound in g/ha | efficacy | | Colby's formula |
| (I) + | | | 0.5 | | | |
| fenpiclonil (XXVIII) | {close oversize brace} | 1:5 | + | {close oversize brace} | 80 | 30 |
| (27) | | | 2.5 | | | |

TABLE 6.12
Sphaerotheca test (cucumber)/protective

| | Application rate | |
|---|---|---|
| | of active | |
| Active compound known: compound in g/ha | % Efficacy | |
| Compound of the formula (I) 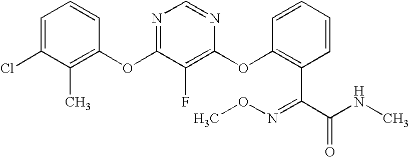 | 0.5 | 30 |
| fludioxonil (XXX) (29) 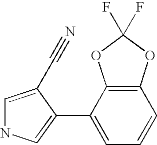 | 2.5 | 0 |

Mixture according to the invention:

| | | | Application | | | Expected value, |
|---|---|---|---|---|---|---|
| | Mixing | | rate of active | Actual | | calculated using |
| | ratio | | compound in g/ha | efficacy | | Colby's formula |
| (I) + | | | 0.5 | | | |
| fludioxonil (XXX) | {close oversize brace} | 1:5 | + | {close oversize brace} | 77 | 30 |
| (29) | | | 2.5 | | | |

TABLE 6.13
Sphaerotheca test (cucumber)/protective

| | Application rate | |
|---|---|---|
| | of active | |
| Active compound known: compound in g/ha | % Efficacy | |
| Compound of the formula (I) 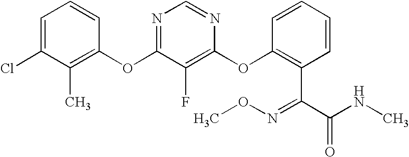 | 1 | 69 |
| fosetyl-Al (XLVII) (46) 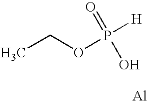 | 10 | 0 |

Mixture according to the invention:

| | | | Application | | | Expected value, |
|---|---|---|---|---|---|---|
| | Mixing | | rate of active | Actual | | calculated using |
| | ratio | | compound in g/ha | efficacy | | Colby's formula |
| (I) + | | | 1 | | | |
| fosetyl-Al (XLVII) | {close oversize brace} | 1:10 | + | {close oversize brace} | 87 | 69 |
| (46) | | | 1 | | | |

TABLE 6.14
Sphaerotheca test (cucumber)/protective

| | Application rate | |
|---|---|---|
| | of active | |
| Active compound known: compound in g/ha | % Efficacy | |
| Compound of the formula (I) 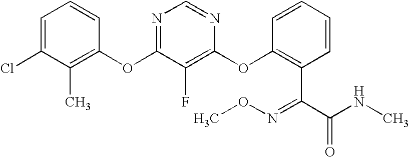 | 2 | 82 |
| kresoxim-methyl (XVI)(15) 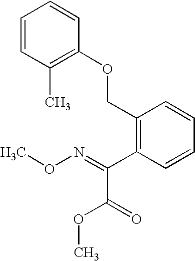 | 2 | 0 |

Mixture according to the invention:

| | | | Application | | | Expected value, |
|---|---|---|---|---|---|---|
| | Mixing | | rate of active | Actual | | calculated using |
| | ratio | | compound in g/ha | efficacy | | Colby's formula |
| (I) + | | | 2 | | | |
| kresoxim-methyl (XVI) | {close oversize brace} | 1:1 | + | {close oversize brace} | 93 | 82 |
| (15) | | | 2 | | | |

TABLE 6.15
Sphaerotheca test (cucumber)/protective

| | Application rate | |
|---|---|---|
| | of active | |
| Active compound known: compound in g/ha | % Efficacy | |
| Compound of the formula (I) 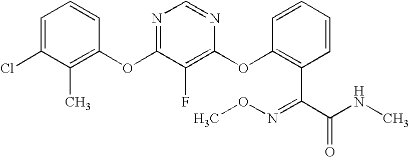 | 1 | 69 |
| azoxystrobin (XVII) (16) 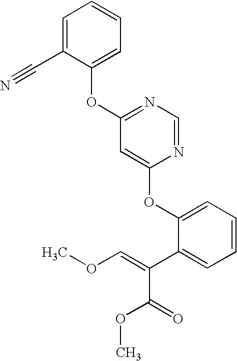 | 1 | 37 |

Mixture according to the invention:

| | | | Application | | | Expected value, |
|---|---|---|---|---|---|---|
| | Mixing | | rate of active | Actual | | calculated using |
| | ratio | | compound in g/ha | efficacy | | Colby's formula |
| (I) + | | | 1 | | | |
| azoxystrobin (XVII) | {close oversize brace} | 1:1 | + | {close oversize brace} | 92 | 80 |
| (16) | | | 1 | | | |

TABLE 6.16
Sphaerotheca test (cucumber)/protective

| | Application rate | |
|---|---|---|
| | of active | |
| Active compound known: compound in g/ha | % Efficacy | |
| Compound of the formula (I) 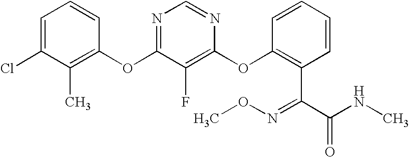 | 2 | 63 |
| trifloxystrobin (LXXVI) (75) 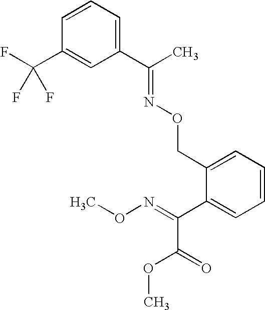 | 2 | 43 |

Mixture according to the invention:

| | | | Application | | | Expected value, |
|---|---|---|---|---|---|---|
| | Mixing | | rate of active | Actual | | calculated using |
| | ratio | | compound in g/ha | efficacy | | Colby's formula |
| (I) + | | | 2 | | | |
| trifloxystrobin | {close oversize brace} | 1:1 | + | {close oversize brace} | 97 | 79 |
| (LXXVI) (75) | | | 1 | | | |

TABLE 6.17
Sphaerotheca test (cucumber)/protective

| | Application rate | |
|---|---|---|
| | of active | |
| Active compound known: compound in g/ha | % Efficacy | |
| Compound of the formula (I) 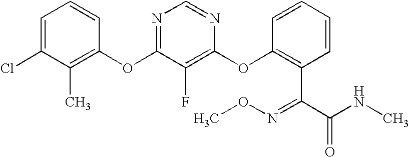 | 2 | 63 |
| (LXXII) (71) 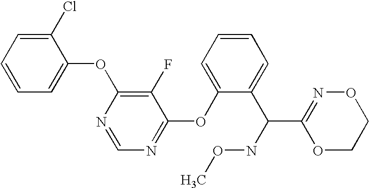 | 2 | 43 |

Mixture according to the invention:

| | | | Application | | | Expected value, |
|---|---|---|---|---|---|---|
| | Mixing | | rate of active | Actual | | calculated using |
| | ratio | | compound in g/ha | efficacy | | Colby's formula |
| (I) | | | 2 | | | |
| + | {close oversize brace} | 1:1 | + | {close oversize brace} | 92 | 79 |
| (LXXII) (71) | | | 1 | | | |

TABLE 6.18
Sphaerotheca test (cucumber)/protective

| | Application rate | |
|---|---|---|
| | of active | |
| Active compound known: compound in g/ha | % Efficacy | |
| Compound of the formula (I) 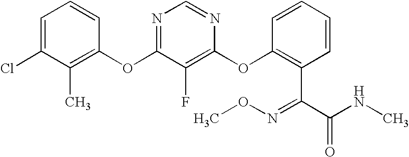 | 2 | 63 |
| picoxystrobin (LXXXIII) (82) 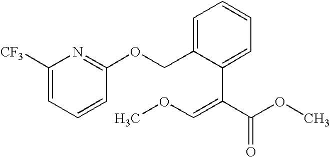 | 2 | 0 |

Mixture according to the invention:

| | | | Application | | | Expected value, |
|---|---|---|---|---|---|---|
| | Mixing | | rate of active | Actual | | calculated using |
| | ratio | | compound in g/ha | efficacy | | Colby's formula |
| (I) + | | | 2 | | | |
| picoxystrobin | {close oversize brace} | 1:1 | + | {close oversize brace} | 90 | 63 |
| (LXXXIII) (82) | | | 1 | | | |

TABLE 6.19
Sphaerotheca test (cucumber)/protective

| | Application rate | |
|---|---|---|
| | of active | |
| Active compound known: compound in g/ha | % Efficacy | |
| Compound of the formula (I) 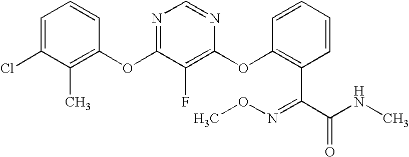 | 1 | 69 |
| fenhexamid (LII) (51) 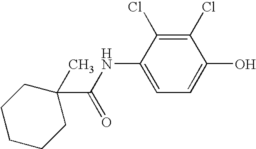 | 5 | 10 |

Mixture according to the invention:

| | | | Application | | | Expected value, |
|---|---|---|---|---|---|---|
| | Mixing | | rate of active | Actual | | calculated using |
| | ratio | | compound in g/ha | efficacy | | Colby's formula |
| (I) | | | 1 | | | |
| + | {close oversize brace} | 1:5 | + | {close oversize brace} | 97 | 72 |
| fenhexamid (LII) (51) | | | 5 | | | |

TABLE 6.20
Sphaerotheca test (cucumber)/protective

| | Application rate of | |
|---|---|---|
| Active compound | active compound | |
| known: | in g/ha | % Efficacy |
| 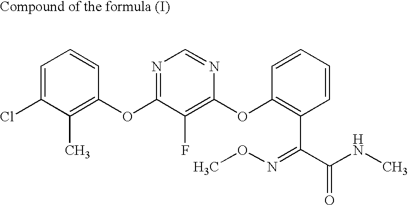 | 1 | 69 |
| 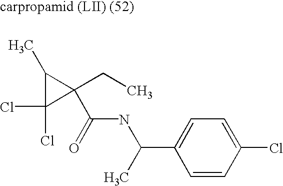 | 5 | 10 |

Mixture according to the invention:

| | | Application | | Expected value, |
|---|---|---|---|---|
| | | rate of active | | calculated |
| | Mixing | compound | Actual | using Colby's |
| | ratio | in g/ha | efficacy | formula |
| (I) +car- propamid (LIII) (52) | 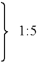 | 1 + 5 | 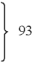 | 72 |

TABLE 6.21
Sphaerotheca test (cucumber)/protective

| | Application rate | |
|---|---|---|
| | of active | |
| Active compound known: compound in g/ha | % Efficacy | |
| Compound of the formula (I) 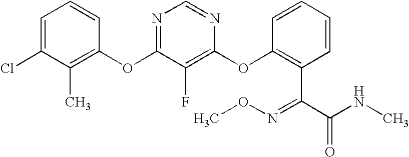 | 1 | 69 |
| copper oxychloride (LXIV) (63) | 50 | 11 |

Mixture according to the invention:

| | | | Application | | | Expected value, |
|---|---|---|---|---|---|---|
| | Mixing | | rate of active | Actual | | calculated using |
| | ratio | | compound in g/ha | efficacy | | Colby's formula |
| (I) + | | | 1 | | | |
| copper oxychloride | {close oversize brace} | 1:50 | + | {close oversize brace} | 93 | 72 |
| (LXIV) (63) | | | 1 | | | |

TABLE 6.22
Sphaerotheca test (cucumber)/protective

| | Application rate | |
|---|---|---|
| | of active | |
| Active compound known: compound in g/ha | % Efficacy | |
| Compound of the formula (I) 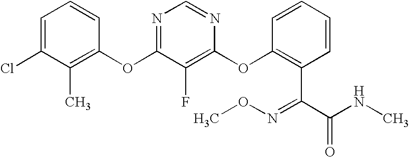 | 1 | 69 |
| spiroxamin (II) (1) 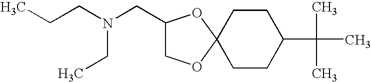 | 5 | 0 |

Mixture according to the invention:

| | | | Application | | | Expected value, |
|---|---|---|---|---|---|---|
| | Mixing | | rate of active | Actual | | calculated using |
| | ratio | | compound in g/ha | efficacy | | Colby's formula |
| (I) | | | 1 | | | |
| + | {close oversize brace} | 1:5 | + | {close oversize brace} | 97 | 69 |
| spiroxamin (II) (1) | | | 5 | | | |

TABLE 6.23
Sphaerotheca test (cucumber)/protective

| | Application rate | |
|---|---|---|
| | of active | |
| Active compound known: compound in g/ha | % Efficacy | |
| Compound of the formula (I) 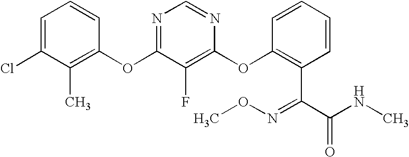 | 1 | 69 |
| mepanipyrim (L) (49) 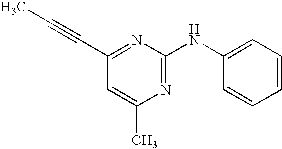 | 10 | 11 |

Mixture according to the invention:

| | | | Application | | | Expected value, |
|---|---|---|---|---|---|---|
| | Mixing | | rate of active | Actual | | calculated using |
| | ratio | | compound in g/ha | efficacy | | Colby's formula |
| (I) | | | 1 | | | |
| + | {close oversize brace} | 1:10 | + | {close oversize brace} | 94 | 72 |
| mepanipyrim (L) (49) | | | 10 | | | |

TABLE 6.24
Sphaerotheca test (cucumber)/protective

| | Application rate | |
|---|---|---|
| | of active | |
| Active compound known: compound in g/ha | % Efficacy | |
| Compound of the formula (I) 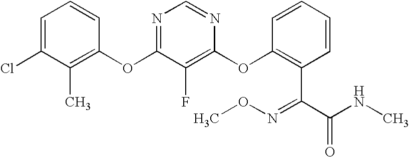 | 1 | 69 |
| pencycyron (XXXVIII) (37) 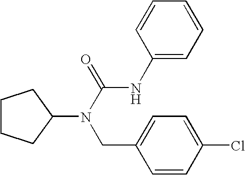 | 5 | 30 |

Mixture according to the invention:

| | | | Application | | | Expected value, |
|---|---|---|---|---|---|---|
| | Mixing | | rate of active | Actual | | calculated using |
| | ratio | | compound in g/ha | efficacy | | Colby's formula |
| (I) + | | | 1 | | | |
| pencycyron (XXXVIII) | {close oversize brace} | 1:5 | + | {close oversize brace} | 93 | 78 |
| (37) | | | 5 | | | |

TABLE 6.25
Sphaerotheca test (cucumber)/protective

| | Application rate | |
|---|---|---|
| | of active | |
| Active compound known: compound in g/ha | % Efficacy | |
| Compound of the formula (I) 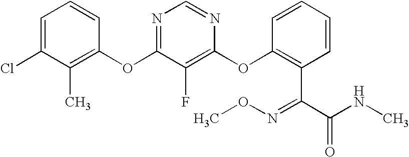 | 1 | 69 |
| procymidone (XLII) (41) 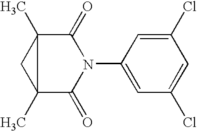 | 5 | 0 |

Mixture according to the invention:

| | | | Application | | | Expected value, |
|---|---|---|---|---|---|---|
| | Mixing | | rate of active | Actual | | calculated using |
| | ratio | | compound in g/ha | efficacy | | Colby's formula |
| (I) + | | | 1 | | | |
| procymidone (XLII) | {close oversize brace} | 1:5 | + | {close oversize brace} | 92 | 69 |
| (41) | | | 5 | | | |

TABLE 6.26
Sphaerotheca test (cucumber)/protective

| | Application rate | |
|---|---|---|
| | of active | |
| Active compound known: compound in g/ha | % Efficacy | |
| Compound of the formula (I) 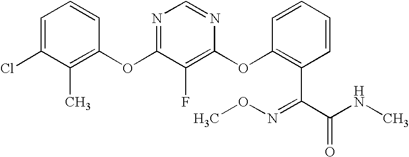 | 0.5 | 30 |
| pyrimethanil (XLIX)(48) 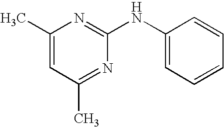 | 5 | 11 |

Mixture according to the invention:

| | | | Application | | | Expected value, |
|---|---|---|---|---|---|---|
| | Mixing | | rate of active | Actual | | calculated using |
| | ratio | | compound in g/ha | efficacy | | Colby's formula |
| (I) + | | | 0.5 | | | |
| pyrimethanil (XLIX) | {close oversize brace} | 1:10 | + | {close oversize brace} | 85 | 38 |
| (48) | | | 5 | | | |

TABLE 6.27
Sphaerotheca test (cucumber)/protective

| | Application rate | |
|---|---|---|
| | of active | |
| Active compound known: compound in g/ha | % Efficacy | |
| Compound of the formula (I) 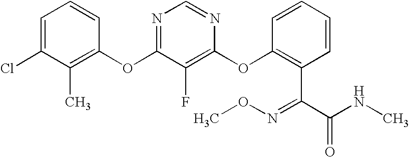 | 1 | 69 |
| zoxamide (LXXIII)(72) 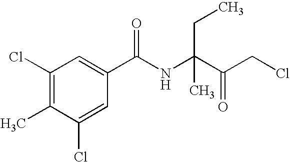 | 1 | 0 |

Mixture according to the invention:

| | | | Application | | | Expected value, |
|---|---|---|---|---|---|---|
| | Mixing | | rate of active | Actual | | calculated using |
| | ratio | | compound in g/ha | efficacy | | Colby's formula |
| (I) + | | | 1 | | | |
| zoxamide (LXXIII) | {close oversize brace} | 1:1 | + | {close oversize brace} | 88 | 69 |
| (72) | | | 1 | | | |

TABLE 6.28
Sphaerotheca test (cucumber)/protective

| | Application rate | |
|---|---|---|
| | of active | |
| Active compound known: compound in g/ha | % Efficacy | |
| Compound of the formula (I) 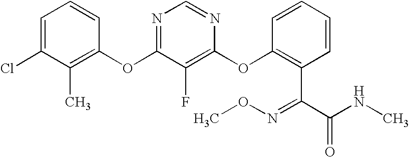 | 1 | 69 |
| metalaxyl (XXVII)(26) 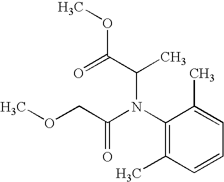 | 1 | 11 |

Mixture according to the invention:

| | | | Application | | | Expected value, |
|---|---|---|---|---|---|---|
| | Mixing | | rate of active | Actual | | calculated using |
| | ratio | | compound in g/ha | efficacy | | Colby's formula |
| (I) + | | | 1 | | | |
| metalaxyl (XXVII) | {close oversize brace} | 1:1 | + | {close oversize brace} | 94 | 72 |
| (26) | | | 1 | | | |

TABLE 6.29
Sphaerotheca test (cucumber)/protective

| | Application rate | |
|---|---|---|
| | of active | |
| Active compound known: compound in g/ha | % Efficacy | |
| Compound of the formula (I) 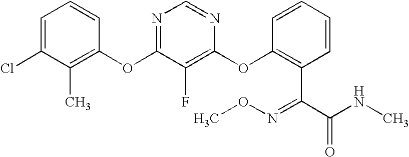 | 1 | 69 |
| iprodione (LXV) (64) 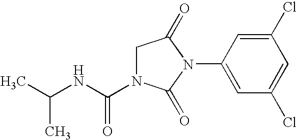 | 5 | 0 |

Mixture according to the invention:

| | | | Application | | | Expected value, |
|---|---|---|---|---|---|---|
| | Mixing | | rate of active | Actual | | calculated using |
| | ratio | | compound in g/ha | efficacy | | Colby's formula |
| (I) | | | 1 | | | |
| + | {close oversize brace} | 1:5 | + | {close oversize brace} | 87 | 69 |
| iprodione (LXV) (64) | | | 5 | | | |

TABLE 6.30
Sphaerotheca test (cucumber)/protective

| | Application rate of | |
|---|---|---|
| Active compound | active compound | |
| known: | in g/ha | % Efficacy |
| 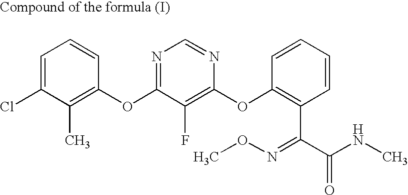 | 1 | 69 |
| 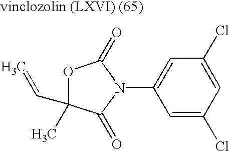 | 5 | 10 |

Mixture according to the invention:

| | | Application | | Expected value, |
|---|---|---|---|---|
| | | rate of active | | calculated |
| | Mixing | compound | Actual | using Colby's |
| | ratio | in g/ha | efficacy | formula |
| (I) +vinclozolin (LXVI) (65) | 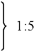 | 1 + 5 | 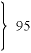 | 72 |

TABLE 6.31
Sphaerotheca test (cucumber)/protective

| | Application rate of | |
|---|---|---|
| Active compound | active compound | |
| known: | in g/ha | % Efficacy |
| 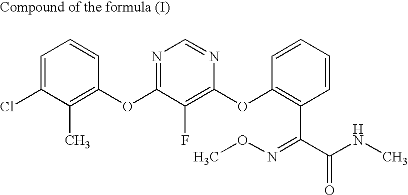 | 0.5 | 30 |
| 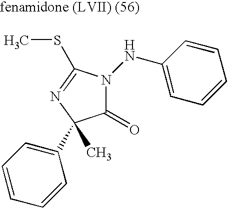 | 0.5 | 0 |

Mixture according to the invention:

| | | Application | | Expected value, |
|---|---|---|---|---|
| | | rate of active | | calculated |
| | Mixing | compound | Actual | using Colby's |
| | ratio | in g/ha | efficacy | formula |
| (I) +fenamidone (LVII) (56) | 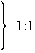 | 0.5 + 0.5 | 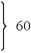 | 30 |

TABLE 6.32
Sphaerotheca test (cucumber)/protective

| | Application rate of | |
|---|---|---|
| Active compound | active compound | |
| known: | in g/ha | % Efficacy |
| 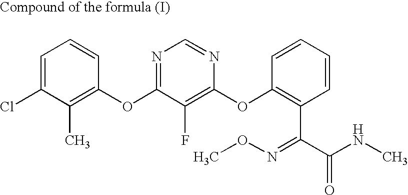 | 0.5 | 30 |
| sulphur (LXII) (62) | 25 | 0 |

Mixture according to the invention:

| | | Application | | Expected value, |
|---|---|---|---|---|
| | | rate of active | | calculated |
| | Mixing | compound | Actual | using Colby's |
| | ratio | in g/ha | efficacy | formula |
| (I) +sulphur (LXIII) (62) | 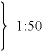 | 0.5 + 25 | 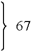 | 30 |

TABLE 6.33
Sphaerotheca test (cucumber)/protective

| | Application rate of | |
|---|---|---|
| Active compound | active compound | |
| known: | in g/ha | % Efficacy |
| 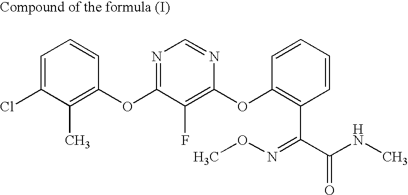 | 1 | 69 |
| 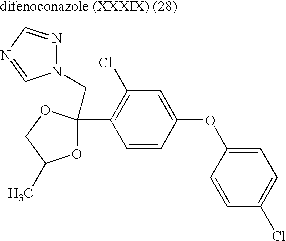 | 5 | 14 |

Mixture according to the invention:

| | | Application | | Expected value, |
|---|---|---|---|---|
| | | rate of active | | calculated |
| | Mixing | compound | Actual | using Colby's |
| | ratio | in g/ha | efficacy | formula |
| (I) +difenoconazole (XXXIX) (28) | 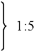 | 1 + 5 | 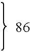 | 73 |

TABLE 6.34
Sphaerotheca test (cucumber)/protective

| | Application rate of | |
|---|---|---|
| Active compound | active compound | |
| known: | in g/ha | % Efficacy |
| 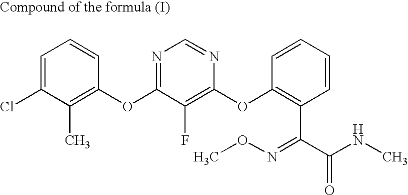 | 0.5 | 30 |
| 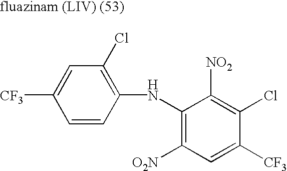 | 2.5 | 0 |

Mixture according to the invention:

| | | Application | | Expected value, |
|---|---|---|---|---|
| | | rate of active | | calculated |
| | Mixing | compound | Actual | using Colby's |
| | ratio | in g/ha | efficacy | formula |
| (I) +fluazinam (LIV) (53) | 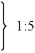 | 0.5 + 2.5 | 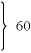 | 30 |

TABLE 6.35
Sphaerotheca test (cucumber)/protective

| | Application rate of | |
|---|---|---|
| Active compound | active compound | |
| known: | in g/ha | % Efficacy |
| 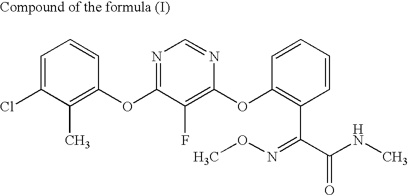 | 2 | 82 |
| 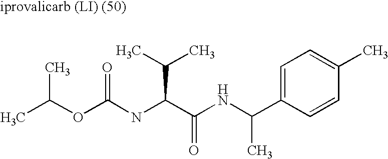 | 2 | 0 |

Mixture according to the invention:

| | | Application | | Expected value, |
|---|---|---|---|---|
| | | rate of active | | calculated |
| | Mixing | compound | Actual | using Colby's |
| | ratio | in g/ha | efficacy | formula |
| (I) +iprovalicarb (LI) (50) | 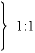 | 2 + 2 | 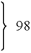 | 82 |

TABLE 6.36
Sphaerotheca test (cucumber)/protective

| | Application rate of | |
|---|---|---|
| Active compound | active compound | |
| known: | in g/ha | % Efficacy |
| 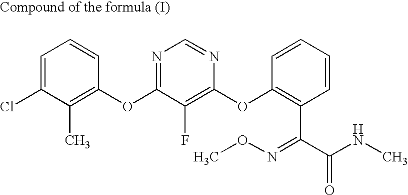 | 2 | 50 |
| 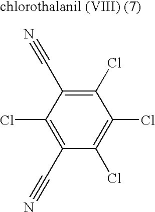 | 40 | 0 |

Mixture according to the invention:

| | | Application | | Expected value, |
|---|---|---|---|---|
| | | rate of active | | calculated |
| | Mixing | compound | Actual | using Colby's |
| | ratio | in g/ha | efficacy | formula |
| (I) +chlorothalonil (VIII) (7) | 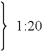 | 2 + 40 | 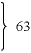 | 50 |

TABLE 6.37
Sphaerotheca test (cucumber)/protective

| | Application rate of | |
|---|---|---|
| Active compound | active compound | |
| known: | in g/ha | % Efficacy |
| 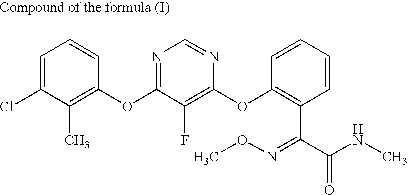 | 2 | 50 |
| 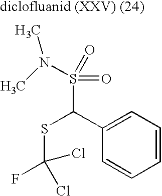 | 40 | 0 |

Mixture according to the invention:

| | | Application | | Expected value, |
|---|---|---|---|---|
| | | rate of active | | calculated |
| | Mixing | compound | Actual | using Colby's |
| | ratio | in g/ha | efficacy | formula |
| (I) +dicloflunid (XXV) (24) | 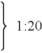 | 2 + 40 | 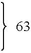 | 50 |

TABLE 6.38
Sphaerotheca test (cucumber)/protective

| | Application rate of | |
|---|---|---|
| Active compound | active compound | |
| known: | in g/ha | % Efficacy |
| 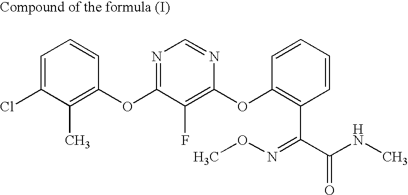 | 2 | 50 |
| 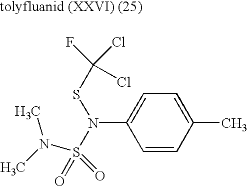 | 40 | 0 |

Mixture according to the invention:

| | | Application | | Expected value, |
|---|---|---|---|---|
| | | rate of active | | calculated |
| | Mixing | compound | Actual | using Colby's |
| | ratio | in g/ha | efficacy | formula |
| (I) +tolyfluanid (XXVI) (25) | 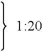 | 2 + 40 | 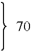 | 50 |

TABLE 6.39
Sphaerotheca test (cucumber)/protective

| | Application rate of | |
|---|---|---|
| Active compound | active compound | |
| known: | in g/ha | % Efficacy |
| 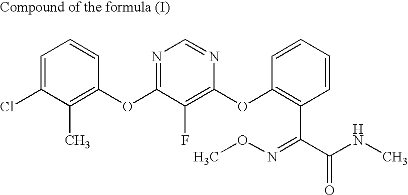 | 2 | 50 |
| 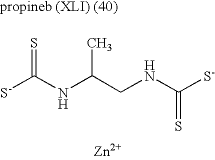 | 40 | 0 |

Mixture according to the invention:

| | | Application | | Expected value, |
|---|---|---|---|---|
| | | rate of active | | calculated |
| | Mixing | compound | Actual | using Colby's |
| | ratio | in g/ha | efficacy | formula |
| (I) +propineb (XLI) (40) | 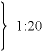 | 2 + 40 | 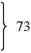 | 50 |

TABLE 6.40
Sphaerotheca test (cucumber)/protective

| | Application rate of | |
|---|---|---|
| Active compound | active compound | |
| known: | in g/ha | % Efficacy |
| 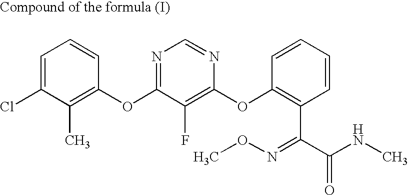 | 2 | 50 |
| 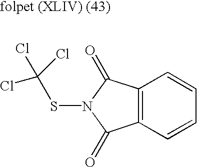 | 40 | 0 |

Mixture according to the invention

| | | Application | | Expected value, |
|---|---|---|---|---|
| | | rate of active | | calculated |
| | Mixing | compound | Actual | using Colby's |
| | ratio | in g/ha | efficacy | formula |
| (I) +folpet (XLIV) (43) | 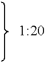 | 2 + 40 | 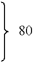 | 50 |

TABLE 6.41
Sphaerotheca test (cucumber)/protective

| Active compound | Application rate of | |
|---|---|---|
| known: | active compound | |
| | in g/ha | % Efficacy |
| 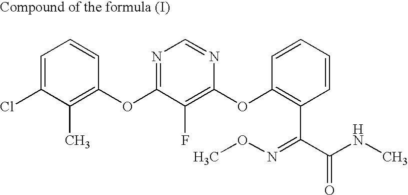 | 0.5 | 30 |
| 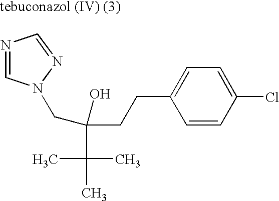 | 2.5 | 0 |

Mixture according to the invention

| | | Application | | Expected value, |
|---|---|---|---|---|
| | | rate of active | | calculated |
| | Mixing | compound | Actual | using Colby's |
| | ratio | in g/ha | efficacy | formula |
| (I) +tebuco- nazol (IV) (3) | 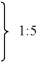 | 0.5 + 2.5 | 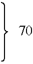 | 30 |

1. Active compound combinations, comprising at least one compound of the formula 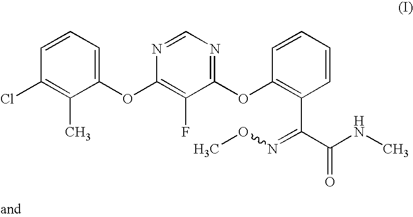
(1) 8-t-butyl-2-(N-ethyl-N-n-propyl-amino)-methyl-1,4-dioxaspiro-[5,4]-decane (reference: EP-A-0 281 842) of the formula 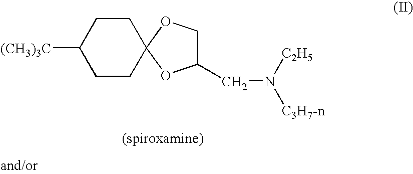
(2) 5,7-dichloro-4-(4-fluorophenoxy)-quinoline (reference: EP-A-326 330) of the formula 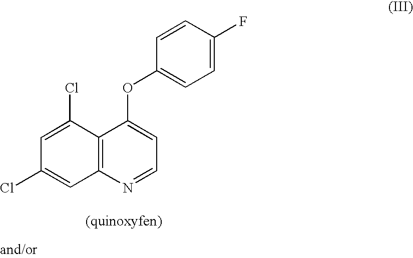
(3) the triazole derivative (reference: EP-A-0 040 345) of the formula 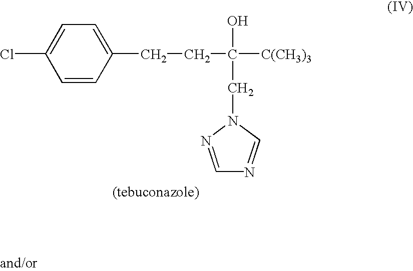
(4) 1-[3-[4-(1,1-dimethylethyl)phenyl]-2-methylpropyl]piperidine (reference: DE-A-2 752 153) of the formula 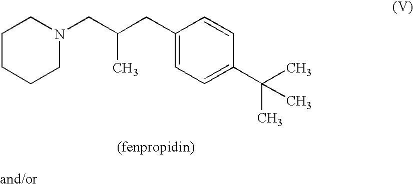
(5) (+−)-cis-4-[3-[4-(1,1-dimethylethyl)phenyl]-2-methylpropyl]-2,6-dimethylmorpholine (reference: DE-A-2 656 747) of the formula 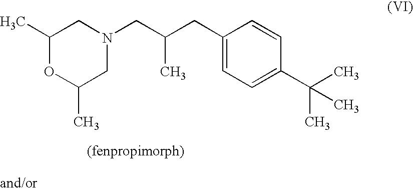
(6) N-(1-cyano-1,2-dimethylpropyl)-2-(2,4-dichlorophenoxy)-propane-amide (reference: EP-A 262 393) of the formula 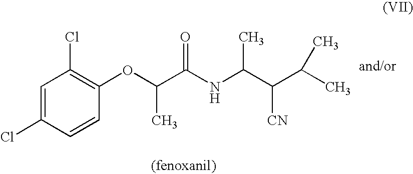
(7) tetrachloro-isophthalo-dinitrile (reference: U.S. Pat. No. 3,290,353) of the formula 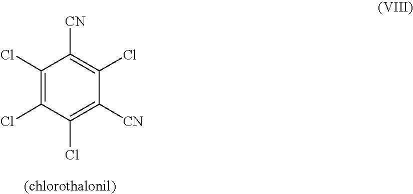
and/or
(8) 1-(4-chloro-phenoxy)-3,3-dimethyl-1-(1,2,4-triazol-1-yl)-butan-2-one (reference: DE-A-22 01 063) of the formula 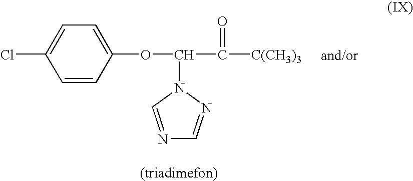
(9) 1-(4-chloro-phenoxy)-3,3-dimethyl-1-(1,2,4-triazol-1-yl)-butan-2-ole (reference: DE-A-2 324 010) of the formula 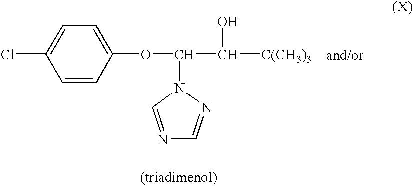
(10) the triazole (reference: EP-A-196 038) of the formula 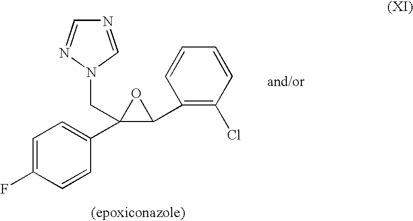
(11) the triazole (reference: EP-A-329 397) of the formula 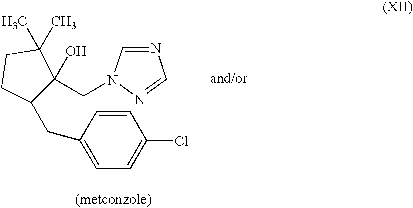
(12) the triazole (reference: EP-A-183 458) of the formula 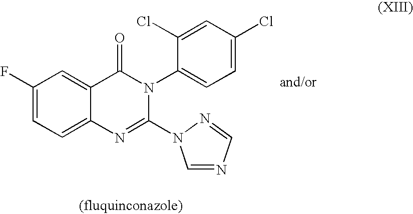
(13) the triazole (reference: DE-A-3 406 993) of the formula 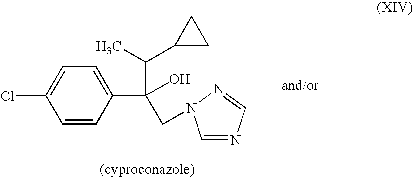
(14) the triazole (reference: Pesticide Manual, 9th. Ed. (1991), page 654) of the formula 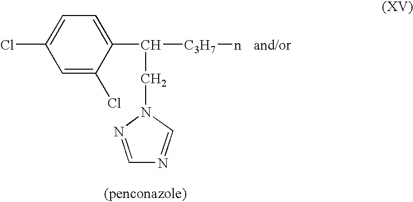
(15) the compound (reference: EP-A-253 213) of the formula 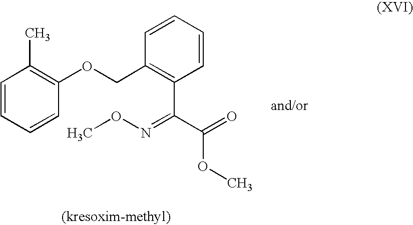
(16) the compound (reference: EP-A-0 382 375) of the formula 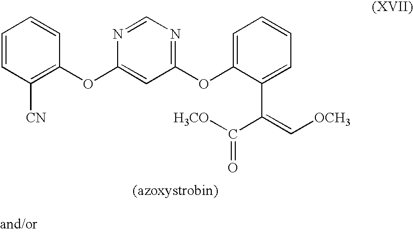
(17) the compound (reference: EP-A-0 310 550) of the formula 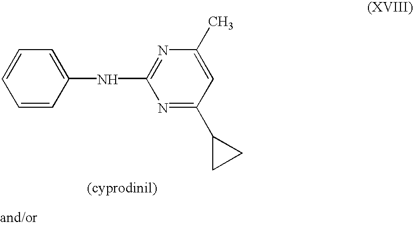
(18) N,N′″-(iminodi-8,1-octanediyl)bis-guanidine triacetate (reference:
EP-A-155 509) of the formula 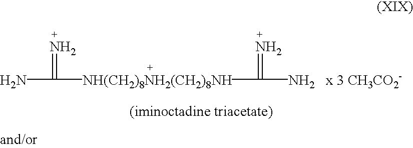
(19) the triazole (reference: EP-A-068 813) of the formula 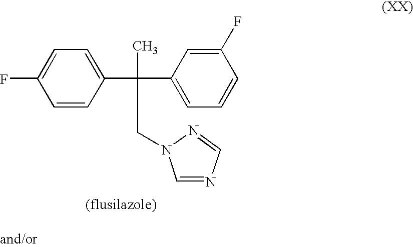
(20) the imidazole derivative (reference: DE-A-2 429 523) of the formula 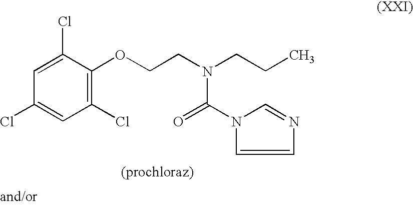
(21) the triazole (reference: DE-A-2 551 560) of the formula 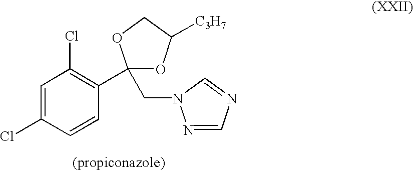
and/or
(22) 1-(4-phenyl-phenoxy)-3,3-dimethyl-1-(1,2,4-triazol-1-yl)-butan-2-ol (reference: DE-A-2 324 010) of the formula 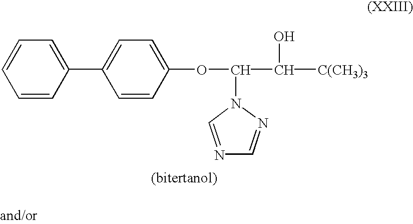
(23) 1-[(6-chloro-3-pyridinyl)-methyl]-N-nitro-2-imidazolidinimine (reference: Pesticide Manual, 9th. Ed. (1991), pace 491) of the formula 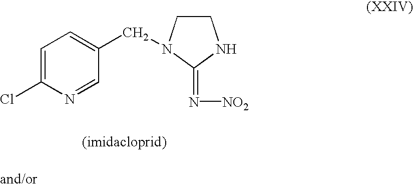
(24) the aniline derivative (reference: DE-A-1 193 498) of the formula 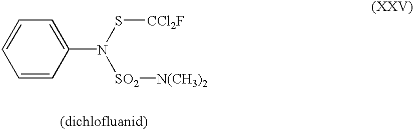
and/or
(25) the aniline derivative (reference: DE-A-1 19 34 98) of the formula 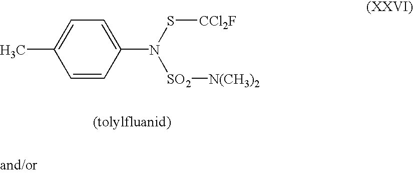
(26) the aniline derivative (reference: Pesticide Manual, 9th. Ed. (1991), page 554) of the formula 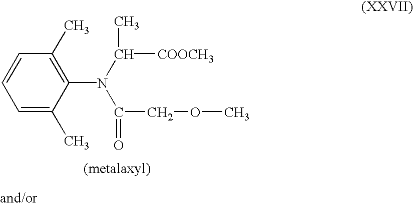
(27) 4-(2,3-dichlorophenyl)-1H-pyrrole-3-carbonitrile (reference: 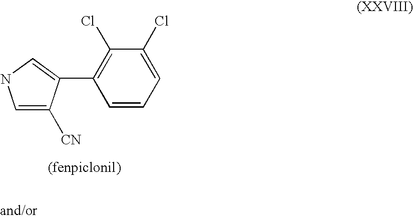
(28) the triazole derivative (reference: EP-A-112 284) of the formula 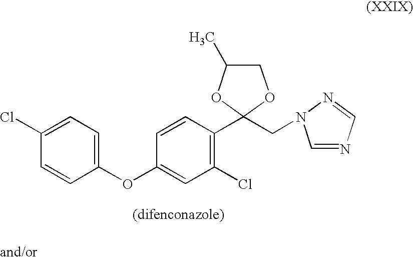
(29) the pyrrole derivative (reference: EP-A-206 999) of the formula 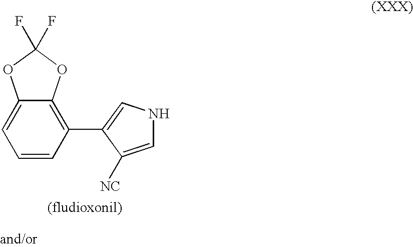
(30) the benzimidazole derivative (reference: U.S. Pat. No. 3,010,968) of the formula 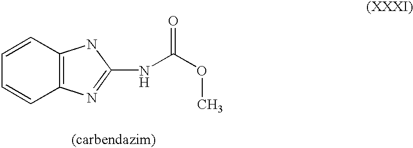
and/or
(31) the compound (reference: CASRN (3878-19-1)) of the formula 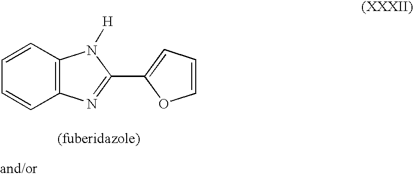
(32) the imidazole derivative (reference: DE-A-2 063 857) of the formula 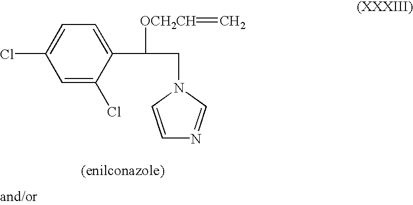
(33) the imadizole derivative of the formula 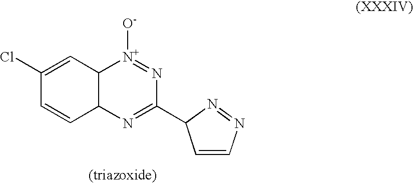
and/or
(34) the compound (reference: DE-A-2 709 264) of the formula 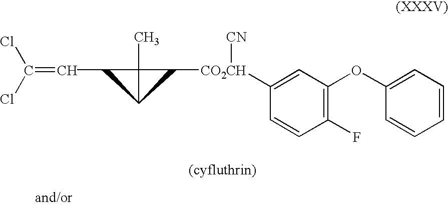
(35) a guanidine derivative (reference: Pesticide Manual, 9th. Ed. (1991), page 461) of the formula 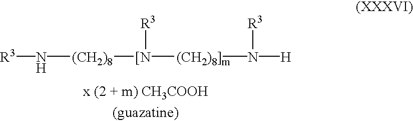
in which
m represents integers from 0 to 5 and
R³ represents hydrogen (17 to 23%) or the radical of the formula 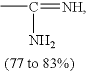
and/or
(36) the benzothiadiazole derivative (reference: EP-A-0 313 512) of the formula 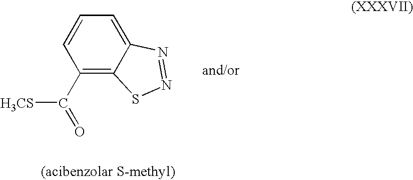
(37) the urea derivative (reference: DE-A-2 732 257) of the formula 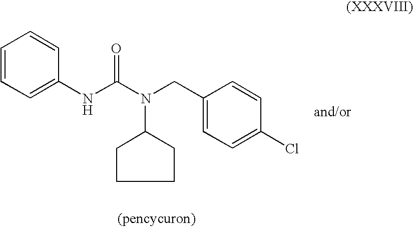
(38) the benzamide derivative (reference: DE-A-2 731 522) of the formula 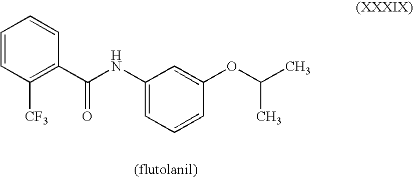
and/or
(39) the benzothiazole derivative (reference: DE-A-2 250 077) of the formula 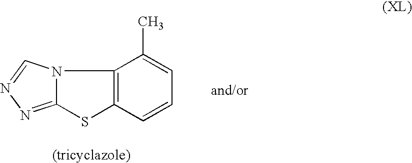
(40) the zinc propylene-1,2-bis-(dithiocarbamidate) (reference: Pesticide Manual, 9th. Ed. (1991), page 726) of the formula 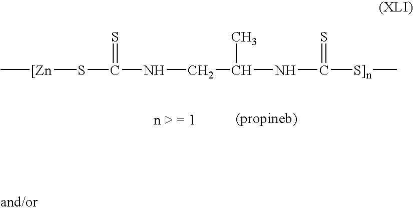
(41) the compound (reference: DE-A-2 012 656) of the formula 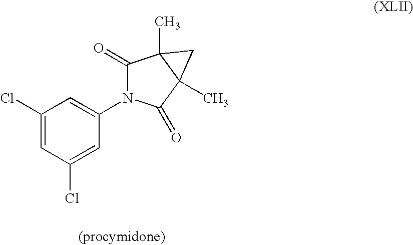
and/or
(42) a thiocarbamate (reference: Pesticide Manual, 9th. Ed. (1991)) of the formula 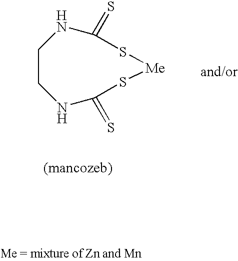
(43) the phthalimide derivative (reference: Pesticide Manual, 9th. Ed.
(1991), page 431) of the formula 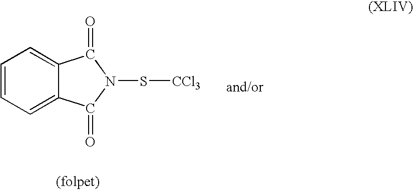
(44) the morpholine derivative (reference: EP-A-0 219 756) of the formula 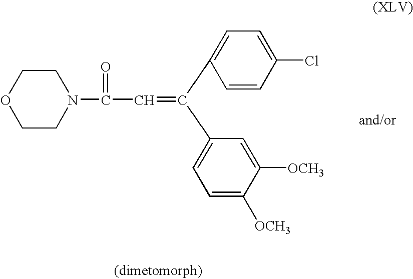
(45) the cyanoxime derivative (reference: Pesticide Manual, 9th. Ed.
(1991), page 206) of the formula 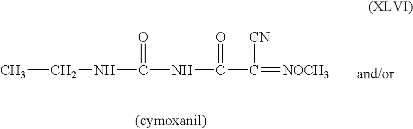
(46) the phosphorus compound (reference: Pesticide Manual, 9th. Ed. (1991), page 443) of the formula 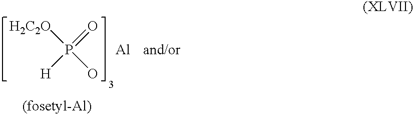
(47) the oxazolidindione (reference: EP-A-0 393 911) of the formula 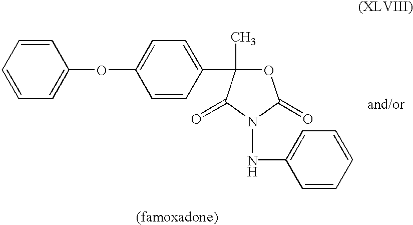
(48) the pyrimidine derivative (reference: EP-A-0 270 111) of the formula 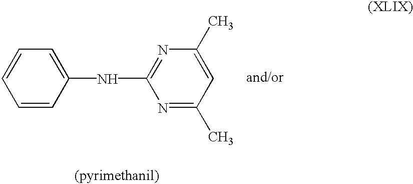
(49) the pyrimidine derivative (reference: EP-A-0 270 111) of the formula 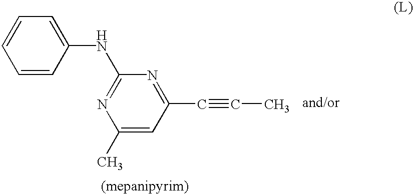
(50) the compound (reference: EP-A-0 472 996) of the formula 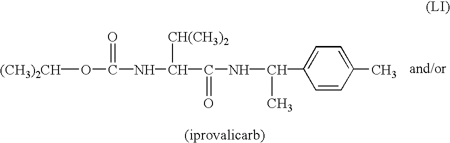
(51) the aniline derivative (reference: EP-A-0 339 418) of the formula 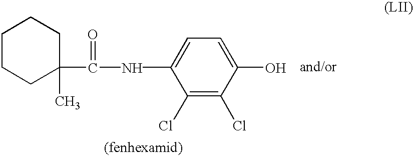
(52) N-[1-(4-chloro-phenyl)-ethyl]-2,2-dichloro-1-ethyl-3-methyl-cyclo-propane-carboxamide (reference: EP-A-0 341 475) of the formula 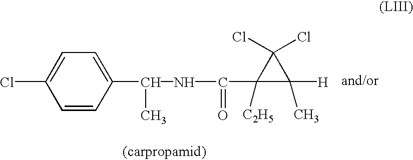
(53) the pyridinamine (reference: EP-A-0 031 257) of the formula 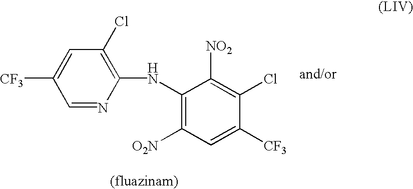
(54) the dicarboxime derivative (reference: U.S. Pat. No. 2,553,770) of the formula 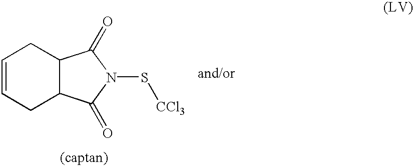
(55) the compound (reference: DE-A-1 100 372) of the formula 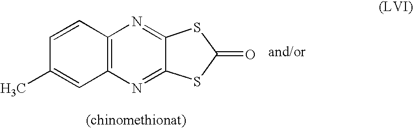
(56) the compound (reference: EP-A-0 629 616) of the formula 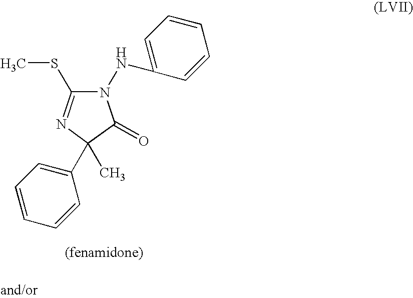
(57) the compound (reference: EP-A-376 279) of the formula 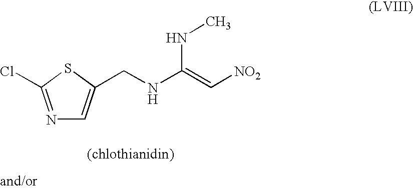
(58) the compound (reference: EP-A-235 725) of the formula 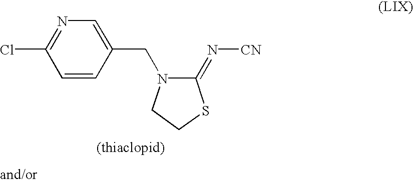
(59) the compound (reference: EP-A-580 553) of the formula 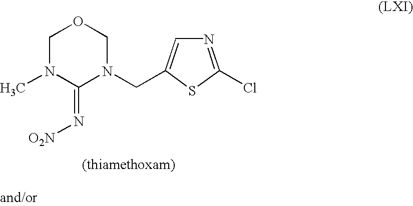
(60) the compound (reference: WO-A-91-4965) of the formula 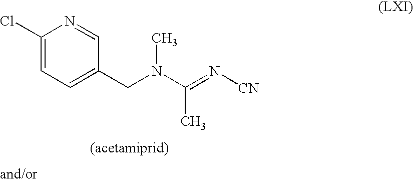
(61) the compound (reference: EP-A-326 330) of the formula 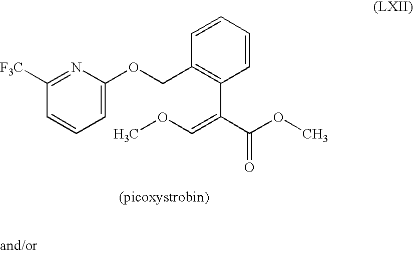
(62) sulphur (LXII)
and/or
(63) copper oxychloride (LXIV)
and/or
(64) the compound (reference: DE-A-2 149 923) of the formula 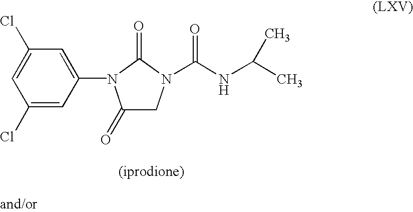
(65) the compound (reference: DE-A-2 207 576) of the formula 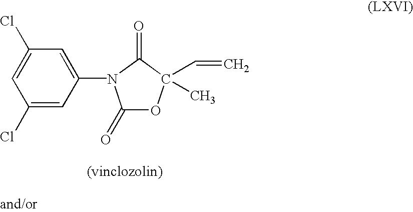
(66) the compound (reference: JP-A-575 584) of the formula 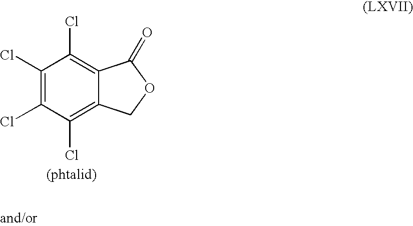
(67) the compound (reference: DE-A-2 300 299) of the formula 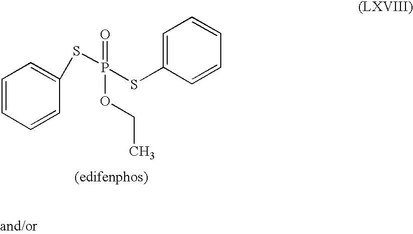
(68) the compound (reference: U.S. Pat. No. 3,917,838) of the formula 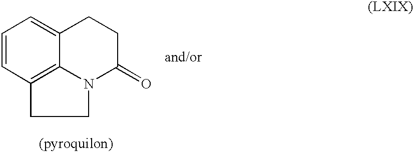
(69) the hydroxyethyl-triazole derivative (reference: WO-A-96-16048) of the formula 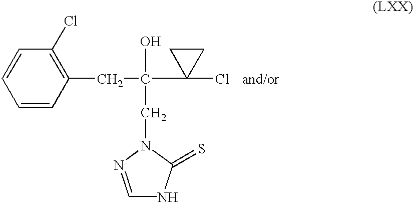
(70) the halogeno-benzimidazole (reference: WO-A-97-06171) of the formula 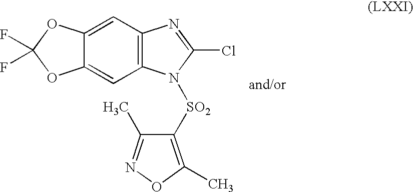
(71) the compound (reference: DE-A-196 02 095) of the formula 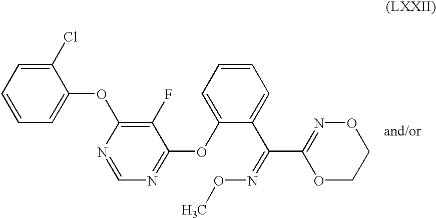
(72) the benzamide derivative (reference: EP-A-0 600 629) of the formula 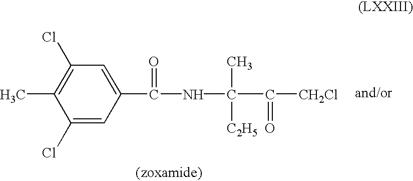
(73) the compound (reference: EP-A-298 196) of the formula 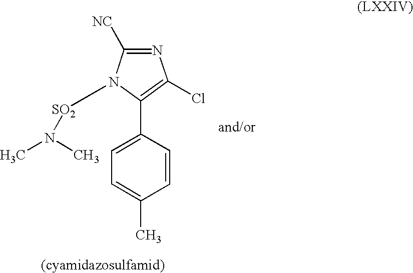
(74) the compound (reference: WO-A-96 18631) of the formula 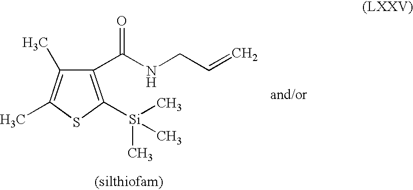
(75) the compound (reference: EP-A-460 575) of the formula 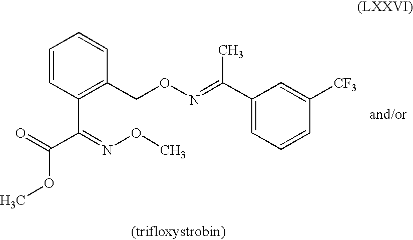
(76) N-methyl-2-(methoxyimino)-2-[2-([1-(3-tri-fluoro-methyl-phenyl)-ethoxy]iminomethyl)phenyl]acetamide (reference: EP-A-596 254) of the formula 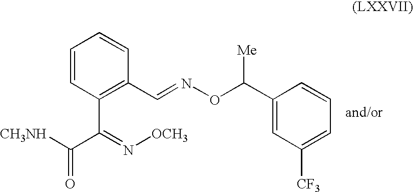
(77) 2-[2-([2-phenyl-2-methoxyimino-1-methylethyl]-imino-oxymethyl)-phenyl]-2-methoxyimino-N-methyl acetamide (reference: WO-A-95-21154) of the formula 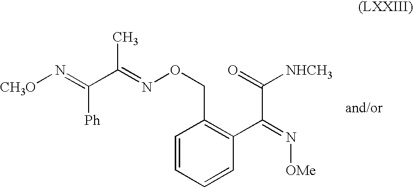
(78) 2-[2-([2-(4-fluorophenyl)-2-methoxyimino-1-methylethyl]iminooxy-methyl)phenyl]-2-methoxyimino-N-methyl-acetamide (reference: WO-A-95-21154) of the formula 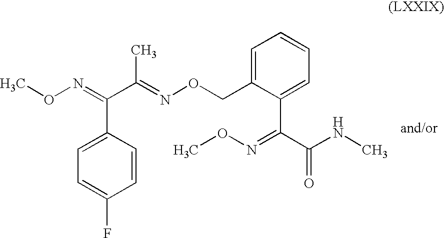
(79) 2-[4-methoxy-3-(1-methylethoxy)-1,4-diazabuta-1,3-dienyl-oxy-methyl]phenyl-2-methoximino-N-methyl-acetamide (reference: DE-A-19 528 651) of the formula 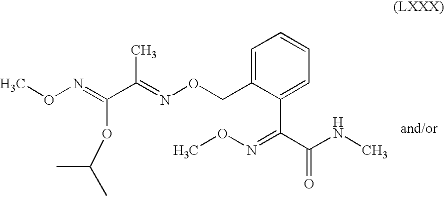
(80) methyl N-(2-[1-(4-chlorophenyl)pyrazol-3-yloxymethyl]phenyl)-N-methoxycarbamate (reference: DE-A-44 23 612) of the formula 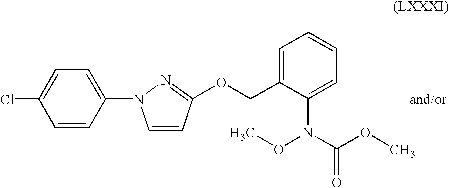
(81) 2,4-dihydro-5-methoxy-2-methyl-4-[2-([([1-(3-tri-fluoro-methyl-phenyl)ethylidene]amino)oxy]methyl)phenyl]-3H-1,2,4-triazol-3-one (reference: WO-A-98-23155) of the formula 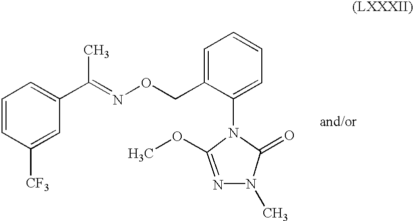
(82) the compound of the formula

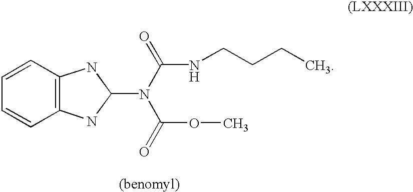

2. Active compound combination according to claim 1, comprising a compound of the formula (I) and one of the compounds 1) to 81) in a mixing ratio of compound of the formula (I) to in each case one compound of the formulae (II) to (LXXXII) of 20:1 to 1:50 parts by weight.

3. Composition according to at least one of claims 1 and 2, characterized in that in the active compound combinations the weight ratio of active compound of the formula (I) to
active compound of group (1) is from 10:1 to 1:20,
active compound of group (2) is from 10:1 to 1:20,
active compound of group (3) is from 10:1 to 1:20,
active compound of group (4) is from 10:1 to 1:20,
active compound of group (5) is from 10:1 to 1:20,
active compound of group (6) is from 10:1 to 1:10,
active compound of group (7) is from 1:1 to 1:50,
active compound of group (8) is from 10:1 to 1:10,
active compound of group (9) is from 10:1 to 1:10,
active compound of group (10) is from 10:1 to 1:10,
active compound of group (11) is from 10: 1 to 1:10,
active compound of group (12) is from 10:1 to 1:10,
active compound of group (13) is from 10:1 to 1:10,
active compound of group (14) is from 10:1 to 1:10,
active compound of group (15) is from 10:1 to 1:10,
active compound of group (16) is from 10:1 to 1:10,
active compound of group (17) is from 5:1 to 1:20,
active compound of group (18) is from 10:1 to 1:10,
active compound of group (19) is from 10:1 to 1:10,
active compound of group (20) is from 10:1 to 1:10,
active compound of group (21) is from 10:1 to 1:10,
active compound of group (22) is from 10:1 to 1:10,
active compound of group (23) is from 20:1 to 1:20,
active compound of group (24) is from 1:1 to 1:50,
active compound of group (25) is from 1:0,1 to 1:50,
active compound of group (26) is from 1:0,1 to 1:50,
active compound of group (27) is from 10:1 to 1:10,
active compound of group (28) is from 10:1 to 1:10,
active compound of group (29) is from 10:1 to 1:10,
active compound of group (30) is from 10:1 to 1:10,
active compound of group (31) is from 20:1 to 1:10,
active compound of group (32) is from 20:1 to 1:10,
active compound of group (33) is from 20:1 to 1:10,
active compound of group (34) is from 20:1 to 1:10,
active compound of group (35) is from 10:1 to 1:10,
active compound of group (36) is from 50:1 to 1:50,
active compound of group (37) is from 10:1 to 1:10,
active compound of group (38) is from 10:1 to 1:10,
active compound of group (39) is from 10:1 to 1:10,
active compound of group (40) is from 1: 1 to 1:50,
active compound of group (41) is from 10:1 to 1:10,
active compound of group (42) is from 1:1 to 1:50,
active compound of group (43) is from 1:1 to 1:50,
active compound of group (44) is from 10:1 to 1:10,
active compound of group (45) is from 10:1 to 1:10,
active compound of group (46) is from 10:1 to 1:50,
active compound of group (47) is from 10:1 to 1:10,
active compound of group (48) is from 5:1 to 1:20,
active compound of group (49) is from 5:1 to 1:20,
active compound of group (50) is from 10:1 to 1:10,
active compound of group (51) is from 10:1 to 1:10,
active compound of group (52) is from 10:1 to 1:10,
active compound of group (53) is from 10:1 to 1:10,
active compound of group (54) is from 5:1 to 1:50,
active compound of group (55) is from 5:1 to 1:50,
active compound of group (56) is from 10:1 to 1:10,
active compound of group (57) is from 20:1 to 1:20,
active compound of group (58) is from 20:1 to 1:20,
active compound of group (59) is from 20:1 to 1:20,
active compound of group (60) is from 20:1 to 1:20,
active compound of group (61) is from 10:1 to 1:10,
active compound of group (62) is from 20:1 to 1:20,
active compound of group (63) is from 20:1 to 1:20,
active compound of group (64) is from 10:1 to 1:10,
active compound of group (65) is from 10:1 to 1:10,
active compound of group (66) is from 10:1 to 1:10,
active compound of group (67) is from 10:1 to 1:10,
active compound of group (68) is from 10:1 to 1:10,
active compound of group (69) is from 20:1 to 1:5,
active compound of group (70) is from 50:1 to 1:10,
active compound of group (71) is from 10:1 to 1:10,
active compound of group (72) is from 50:1 to 1:10,
active compound of group (73) is from 20:1 to 1:5,
active compound of group (74) is from 20:1 to 1:10,
active compound of group (75) is from 10:1 to 1:10,
active compound of group (76) is from 10:1 to 1:10,
active compound of group (77) is from 10:1 to 1:10,
active compound of group (78) is from 10:1 to 1:10,
active compound of group (79) is from 10:1 to 1:10,
active compound of group (80) is from 10:1 to 1:10,
active compound of group (81) is from 10:1 to 1:10,
active compound of group (82) is from 10:1 to 1:10.

4. Method for controlling fungi, characterized in that active compound combinations according to any of claims 1 to 3 are applied to fungi and/or their habitat.

5. Use of active compound combinations according to at least one of claims 1 to 3 for controlling fungi.

6. Process for preparing fungicidal compositions, characterized in that active compound combinations according to at least one of claims 1 to 3 are mixed with extenders and/or surfactants.
